(19) United States
(12) Patent Application Publication
(10) Pub. No.: US 2024/0314028 A1
(43) Pub. Date: Sep. 19, 2024

(54) DATA DISTRIBUTION DEVICE, PROVIDING DEVICE, USAGE DEVICE, DATA DISTRIBUTION SYSTEM, DATA DISTRIBUTION METHOD, DATA PROVISION METHOD, DATA USAGE METHOD, AND PROGRAM

(71) Applicant: NEC CORPORATION, Tokyo (JP)

(72) Inventor: Kouichi Kimura, Tokyo (JP)

(73) Assignee: NEC CORPORATION, Minato-ku, Tokyo (JP)

(21) Appl. No.: 18/267,067

(22) PCT Filed: Dec. 16, 2020
(86) PCT No.: PCT/JP2020/046859

§ 371 Date: Jun. 13, 2023

(51) Int. Cl. H04L 41/0806; H04L 41/06

(52) U.S. Cl. CPC H04L 41/0806; H04L 41/06

(57) ABSTRACT

A data distribution apparatus, includes: a first reception section of receiving first provision information and first request information via a first distribution path; a first determination section of determining whether the first provision information and the first request information satisfy a first condition; a second distribution path notification section of providing notification for prompting a provision apparatus and a usage apparatus to connect to a private second distribution path when the first condition is satisfied; a second reception section of receiving specific second provision information and specific second request information via the second distribution path; a second determination section of determining whether the second provision information and the second request information satisfy a second condition; and a provision notification section of providing notification for prompting the provision apparatus to provide the provision data to the usage apparatus via the second distribution path when the second condition is satisfied.

### TECHNICAL FIELD

The present invention relates to a technique to distribute data from a provision apparatus to a usage apparatus.

### BACKGROUND ART

There are known techniques to distribute data provided by a provider to a user. For example, Patent Literature 1 discloses a technique of setting a channel for transmitting data in a case where a combination of a sales offer by a provider and a purchase offer by a user satisfies a matching condition.

### CITATION LIST

### Patent Literature

[Patent Literature 1]
Specification of Japanese Patent No. 6694048

### SUMMARY OF INVENTION

### Technical Problem

In the related technique described in Patent Literature 1, data is distributed from the provider to the user in response to the fact that the matching condition has been satisfied. Note, however, that even data in which the matching condition is satisfied is not necessarily data that is demanded by a user. In this case, there is a problem that data demanded by the user cannot be obtained. Moreover, distribution of data to a user who does not want the data poses a security problem.

An example aspect of the present invention is accomplished in view of the above problems, and an example of its object is to provide a technique to more reliably provide data demanded by a user, while enhancing security.

### Solution to Problem

A data distribution apparatus according to an example aspect of the present invention includes: a first reception means of receiving first provision information and first request information via a first distribution path, the first provision information pertaining to provision data which is providable by a provision apparatus, and the first request information indicating a request which is related to provision data and made by a usage apparatus; a first determination means of determining whether or not the first provision information and the first request information satisfy a first condition; a second distribution path notification means of providing the provision apparatus and the usage apparatus with notification for prompting the provision apparatus and the usage apparatus to connect to a second distribution path in a case where the first condition is satisfied, the second distribution path being private and different from the first distribution path; a second reception means of receiving second provision information and second request information via the second distribution path, the second provision information pertaining to the provision data and being more specific than the first provision information, and the second request information indicating the request and being more specific than the first request information; a second determination means of determining whether or not the second provision information and the second request information satisfy a second condition; and a provision notification means of providing the provision apparatus with notification for prompting the provision apparatus to provide the provision data to the usage apparatus via the second distribution path in a case where the second condition is satisfied.

A provision apparatus according to an example aspect of the present invention is communicably connected to the above described data distribution apparatus via the first distribution path, and includes: a provision data acquisition means of acquiring the provision data; a first provision information generation means of generating the first provision information based on the provision data; a first provision information transmission means of transmitting the first provision information to the data distribution apparatus via the first distribution path; a second provision information generation means of generating the second provision information based on the provision data upon receipt of notification for prompting connection to the second distribution path; a second provision information transmission means of transmitting the second provision information to the data distribution apparatus via the second distribution path; and a provision data transmission means of transmitting the provision data to the usage apparatus via the second distribution path upon receipt of notification for prompting provision of the provision data.

A usage apparatus according to an example aspect of the present invention is communicably connected to the above described data distribution apparatus via the first distribution path, and includes: an input data acquisition means of acquiring input data indicating the request; a first request information generation means of generating first request information based on the input data; a first request information transmission means of transmitting the first request information to the data distribution apparatus via the first distribution path; a second request information generation means of generating the second request information based on the input data upon receipt of notification for prompting connection to the second distribution path; a second request information transmission means of transmitting the second request information to the data distribution apparatus via the second distribution path; and a provision data reception means of receiving the provision data from the provision apparatus via the second distribution path.

A data distribution system according to an example aspect of the present invention includes the above described data distribution apparatus, the above described provision apparatus, and the above described usage apparatus.

A data distribution method according to an example aspect of the present invention includes: receiving first provision information and first request information via a first distribution path, the first provision information pertaining to provision data which is providable by a provision apparatus, and the first request information indicating a request which is related to provision data and made by a usage apparatus; determining whether or not the first provision information and the first request information satisfy a first condition; providing the provision apparatus and the usage apparatus with notification for prompting the provision apparatus and the usage apparatus to connect to a second distribution path in a case where the first condition is satisfied, the second distribution path being private and different from the first distribution path; receiving second provision information and second request information via the second distribution path, the second provision information pertaining to the provision data and being more specific than the first provision information, and the second request information indicating the request and being more specific than the first request information; determining whether or not the second provision information and the second request information satisfy a second condition; and providing the provision apparatus with notification for prompting the provision apparatus to provide the provision data to the usage apparatus via the second distribution path in a case where the second condition is satisfied.

A data provision method according to an example aspect of the present invention includes: being communicably connected to a data distribution apparatus for carrying out the above described data distribution method via the first distribution path; acquiring the provision data; generating the first provision information based on the provision data; transmitting the first provision information to the data distribution apparatus via the first distribution path; generating the second provision information based on the provision data upon receipt of notification for prompting connection to the second distribution path; transmitting the second provision information to the data distribution apparatus via the second distribution path; and transmitting the provision data to the usage apparatus via the second distribution path upon receipt of notification for prompting provision of the provision data.

A data usage method according to an example aspect of the present invention includes: being communicably connected to a data distribution apparatus for carrying out the above described data distribution method via the first distribution path; acquiring input data indicating the request; generating first request information based on the input data; transmitting the first request information to the data distribution apparatus via the first distribution path; generating the second request information based on the input data upon receipt of notification for prompting connection to the second distribution path; transmitting the second request information to the data distribution apparatus via the second distribution path; and receiving the provision data from the provision apparatus via the second distribution path.

A program according to an example aspect of the present invention is a program for causing a computer to function as a data distribution apparatus, the program causing the computer to function as: a first reception means of receiving first provision information and first request information via a first distribution path, the first provision information pertaining to provision data which is providable by a provision apparatus, and the first request information indicating a request which is related to provision data and made by a usage apparatus; a first determination means of determining whether or not the first provision information and the first request information satisfy a first condition; a second distribution path notification means of providing the provision apparatus and the usage apparatus with notification for prompting the provision apparatus and the usage apparatus to connect to a second distribution path in a case where the first condition is satisfied, the second distribution path being private and different from the first distribution path; a second reception means of receiving second provision information and second request information via the second distribution path, the second provision information pertaining to the provision data and being more specific than the first provision information, and the second request information indicating the request and being more specific than the first request information; a second determination means of determining whether or not the second provision information and the second request information satisfy a second condition; and a provision notification means of providing the provision apparatus with notification for prompting the provision apparatus to provide the provision data to the usage apparatus via the second distribution path in a case where the second condition is satisfied.

A program according to an example aspect of the present invention is a program for causing a computer to function as a provision apparatus, the program being communicably connected to a data distribution apparatus that executes the above described program via the first distribution path, and causing the computer to function as: a provision data acquisition means of acquiring the provision data; a first provision information generation means of generating the first provision information based on the provision data; a first provision information transmission means of transmitting the first provision information to the data distribution apparatus via the first distribution path; a second provision information generation means of generating the second provision information based on the provision data upon receipt of notification for prompting connection to the second distribution path; a second provision information transmission means of transmitting the second provision information to the data distribution apparatus via the second distribution path; and a provision data transmission means of transmitting the provision data to the usage apparatus via the second distribution path upon receipt of notification for prompting provision of the provision data.

A program according to an example aspect of the present invention is a program for causing a computer to function as a usage apparatus, the program being communicably connected to a data distribution apparatus that executes the above described program via the first distribution path, and causing the computer to function as: an input data acquisition means of acquiring input data indicating the request; a first request information generation means of generating first request information based on the input data; a first request information transmission means of transmitting the first request information to the data distribution apparatus via the first distribution path; a second request information generation means of generating the second request information based on the input data upon receipt of notification for prompting connection to the second distribution path; a second request information transmission means of transmitting the second request information to the data distribution apparatus via the second distribution path; and a provision data reception means of receiving the provision data from the provision apparatus via the second distribution path.

### Advantageous Effects of Invention

According to an example aspect of the present invention, it is possible to more reliably provide data demanded by a user, while enhancing security.

### BRIEF DESCRIPTION OF DRAWINGS

FIG. 1 is a block diagram illustrating a configuration of a data distribution system according to a first example embodiment of the present invention.

FIG. 2 is a block diagram illustrating a configuration of a data distribution apparatus according to the first example embodiment of the present invention.

FIG. 3 is a block diagram illustrating a configuration of a provision apparatus according to the first example embodiment of the present invention.

FIG. 4 is a block diagram illustrating a configuration of a usage apparatus according to the first example embodiment of the present invention.

FIG. 5 is a flowchart illustrating a flow of a data distribution method according to the first example embodiment of the present invention.

FIG. 6 is a flowchart illustrating a flow of a data provision method according to the first example embodiment of the present invention.

FIG. 7 is a flowchart illustrating a flow of a data usage method according to the first example embodiment of the present invention.

FIG. 8 is a flowchart illustrating a flow of a variation of the data distribution method according to the first example embodiment of the present invention.

FIG. 9 is a block diagram illustrating an example of a data structure according to a second example embodiment of the present invention.

FIG. 10 is a block diagram illustrating a configuration of a data distribution system according to a third example embodiment of the present invention.

FIG. 11 is a diagram illustrating an example of a data structure according to the third example embodiment of the present invention.

FIG. 12 is a diagram illustrating an example of another data structure according to the third example embodiment of the present invention.

FIG. 13 is a sequence diagram illustrating a flow of an information processing method according to the third example embodiment of the present invention.

FIG. 14 is a sequence diagram continued from FIG. 13.

FIG. 15 is a block diagram illustrating a configuration of a data distribution system according to a fourth example embodiment of the present invention.

FIG. 16 is a diagram illustrating an example of a data structure according to the fourth example embodiment of the present invention.

FIG. 17 is a diagram illustrating an example of another data structure according to the fourth example embodiment of the present invention.

FIG. 18 is a sequence diagram illustrating a flow of an information processing method according to the fourth example embodiment of the present invention.

FIG. 19 is a sequence diagram continued from FIG. 18.

FIG. 20 is a block diagram illustrating a configuration of a data distribution system according to a fifth example embodiment of the present invention.

FIG. 21 is a diagram illustrating an example of a data structure according to the fifth example embodiment of the present invention.

FIG. 22 is a diagram illustrating an example of another data structure according to the fifth example embodiment of the present invention.

FIG. 23 is a sequence diagram illustrating a flow of an information processing method according to the fifth example embodiment of the present invention.

FIG. 24 is a sequence diagram continued from FIG. 23.

FIG. 25 is a block diagram illustrating an example of a hardware configuration of the information processing apparatus according to each of the example embodiments of the present invention.

### EXAMPLE EMBODIMENTS

### First Example Embodiment

The following description will discuss a first example embodiment of the present invention in detail with reference to the drawings. The present example embodiment is a basic form of example embodiments described later.

### <Configuration of Data Distribution System>

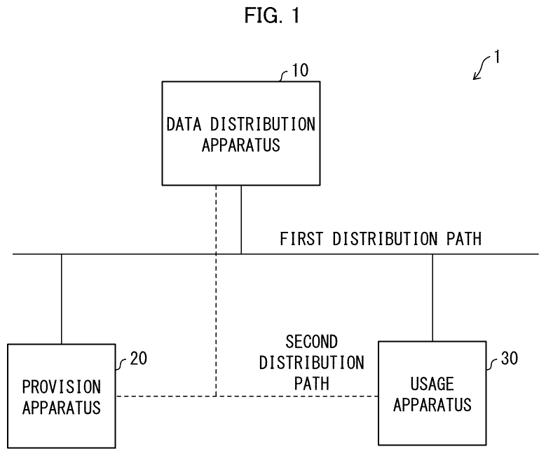

The following description will discuss a configuration of a data distribution system 1 according to the present example embodiment, with reference to FIG. 1. FIG. 1 is a block diagram illustrating the configuration of the data distribution system 1. As illustrated in FIG. 1, the data distribution system 1 includes a data distribution apparatus 10, a provision apparatus 20, and a usage apparatus 30. The data distribution system 1 is a communication system of publish/subscribe type model, and provides provision data from the provision apparatus 20 to the usage apparatus 30 under control of the data distribution apparatus 10.

The data distribution apparatus 10, the provision apparatus 20, and the usage apparatus 30 are communicably connected to each other via a first distribution path. The data distribution apparatus 10, the provision apparatus 20, and the usage apparatus 30 can be communicably connected to each other via a second distribution path. In FIG. 1, a single provision apparatus 20 and a single usage apparatus 30 are illustrated. Note, however, that the number of apparatuses of each type that are included in the data distribution system 1 is not limited to one, and the number of apparatuses of each type can be two or more.

### (Provision Data)

The provision data is data that can be provided by the provision apparatus 20. Examples of the provision data include, but not limited to, picture data, document data, audio data, sensor data, resource data, and the like. Note that the resource data herein is information pertaining to, for example, a resource (e.g., a person, an apparatus, or the like) that is used to carry out a service. The provision apparatus 20 can provide one or more pieces of provision data.

### (First Distribution Path)

The first distribution path is a distribution path that connects the data distribution apparatus 10 with each of the provision apparatus 20 and the usage apparatus 30. The first distribution path connects these apparatuses with each other while the data distribution system 1 is operating. In other words, the first distribution path is permanently established. The first distribution path is a distribution path for carrying out transmission and reception of information with low confidentiality. The first distribution path is constituted by a public network. Examples of the network for realizing the first distribution path include the Internet and a public wireless local area network (LAN). Note, however, that the network for realizing the first distribution path is not limited to the above examples.

### (Second Distribution Path)

The second distribution path is a private distribution path that is different from the first distribution path and that temporarily connect the data distribution apparatus 10, the provision apparatus 20, and the usage apparatus 30 with each other. Here, the term “private” means that connection information to the second distribution path is not disclosed, and the connection information is notified only to the provision apparatus 20 and the usage apparatus 30. Therefore, the second distribution path can be used as a distribution path for carrying out transmission and reception of information having higher confidentiality than information transmitted and received via the first distribution path. Hereinafter, connecting the data distribution apparatus 10, the provision apparatus 20, and the usage apparatus 30 to each other by a second distribution path is referred to also as establishing a second distribution path. In other words, the second distribution path is temporarily established. Specifically, the second distribution path is temporarily established in a case where a first condition (described later) is satisfied in the first distribution path. The second distribution path is constituted by a private network. An example of a network for realizing the second distribution path is a virtual private network (VPN). Note, however, that the network for realizing the second distribution path is not limited to the above example.

Here, while the second distribution path is established, a state of the data distribution system 1 can be any of a first mode and a second mode. The first mode is a state in which a disclosure range of provision data is limited. The second mode is a state in which disclosure of provision data is entirely permitted.

### (Configuration of Data Distribution Apparatus)

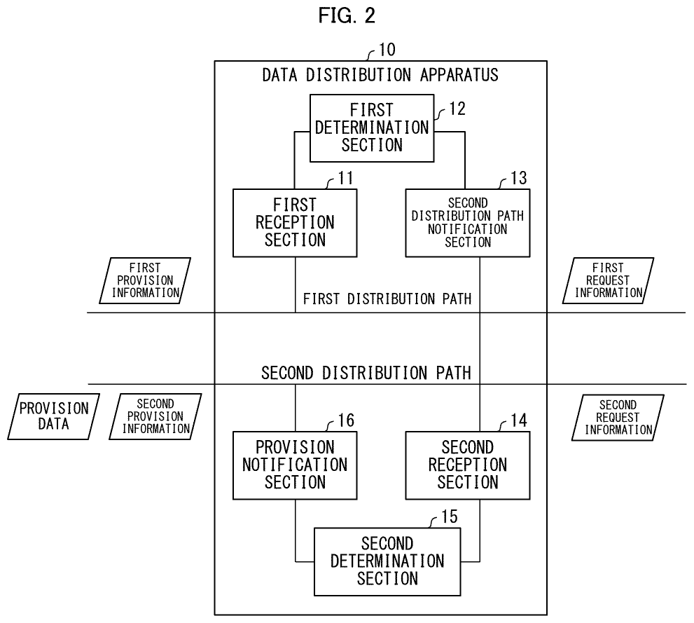

The following description will discuss a configuration of a data distribution apparatus 10, with reference to FIG. 2. FIG. 2 is a block diagram illustrating the configuration of the data distribution apparatus 10. As illustrated in FIG. 2, the data distribution apparatus 10 includes a first reception section 11, a first determination section 12, a second distribution path notification section 13, a second reception section 14, a second determination section 15, and a provision notification section 16. The first reception section 11 is an example configuration for realizing the first reception means recited in claims. The first determination section 12 is an example configuration for realizing the first determination means recited in claims. The second distribution path notification section 13 is an example configuration for realizing the second distribution path notification means recited in claims. The second reception section 14 is an example configuration for realizing the second reception means recited in claims. The second determination section 15 is an example configuration for realizing the second determination means recited in claims. The provision notification section 16 is an example configuration for realizing the provision notification means recited in claims.

The first reception section 11 receives first provision information and first request t information via a first distribution path. The first provision information and the first request information will be described later.

The first determination section 12 determines whether or not the first provision information and the first request information satisfy a first condition. The first condition will be described later.

In a case where the first condition is satisfied, the second distribution path notification section 13 provides the provision apparatus 20 and the usage apparatus 30 with notification for prompting the provision apparatus 20 and the usage apparatus 30 to connect to a second distribution path. Thus, a state of the data distribution system 1 is shifted to a first mode.

The second reception section 14 receives second provision information and second request information via the second distribution path. The second provision information and the second request information will be described later.

The second determination section 15 determines whether or not the second provision information and the second request information satisfy a second condition. The second condition will be described later.

In a case where the second condition is satisfied, the provision notification section 16 provides the provision apparatus 20 with notification for prompting the provision apparatus 20 to provide provision data to the usage apparatus 30 via the second distribution path. Thus, a state of the data distribution system 1 is shifted to a second mode.

### (First Provision Information)

The first provision information is information that pertains to provision data and that is transmitted and received via the first distribution path. The first provision information has a lower level of detail than the second provision information described later. In other words, the first provision information includes information more schematic than the second provision information. Therefore, the first provision information has lower confidentiality than the second provision information.

The first provision information may include, as schematic information, information which is contained in the provision data or information which accompanies the provision data. The first provision information may include, as schematic information, information obtained by analyzing the provision data or information obtained by integrating a plurality of pieces of provision data. Examples of information included in the first provision information include a “classification” of provision data, a “document format” of document data which is provision data, a “color of subject” obtained by analyzing picture data which is provision data, the “number of pieces of provision data” acquired in a particular time zone, and the like. Note, however, that the information included in the first provision information is not limited to these examples.

### (First Request Information)

The first request information indicates a request that is related to provision data, that is made by the usage apparatus 30, and that is transmitted and received via the first distribution path. The first request information has a lower level of detail than the second request information described later. In other words, the first request information is more schematic than the second request information. Therefore, the first request information has lower confidentiality than the second request information.

The first request information is generated from, for example, input data that is input to the usage apparatus 30. Examples of the input data include, but not limited to, picture data, sensor data, and user input information which has been input by a user. The first request information may include, as a schematic request related to the provision data, information which is contained in the input data or information which accompanies the input data. The first request information may include, as a schematic request related to provision data, information obtained by analyzing the input data or information obtained by integrating a plurality of pieces of input data. Examples of information included in the first request information include a “classification” of provision data that a user wants to use, a “document format” of document data that a user wants to use, a “color of subject” included in picture data that a user wants to use, and the like. Note, however, that the information included in the first request information is not limited to these examples.

### (Second Provision Information)

The second provision information is information pertaining to provision data that is transmitted and received via the second distribution path. The second provision information is more specific than the first provision information. Therefore, the second provision information has higher confidentiality than the first provision information.

The second provision information may include, as detailed information, information which is contained in the provision data or information which accompanies the provision data. The first provision information may include, as detailed information, information obtained by analyzing the provision data or information obtained by integrating a plurality of pieces of provision data. Examples of information included in the second provision information include a “preparer” of document data which is provision data, a “face image” extracted from picture data which is provision data, a “movement range of subject” which is obtained from a plurality of pieces of picture data including the same subject, and the like. Note, however, that the information included in the second provision information is not limited to these examples.

### (Second Request Information)

The second request information indicates a request that is related to provision data, that is made by the usage apparatus 30, and that is transmitted and received via the second distribution path. The second request information is more specific than the first request information. Therefore, the second request information has higher confidentiality than the first request information.

The second request information is generated from, for example, the above described input data. The second request information may include, as a detailed request related to the provision data, information which is contained in the input data or information which accompanies the input data. The second request information may include, as a detailed request related to provision data, information obtained by analyzing the input data or information obtained by integrating a plurality of pieces of input data. Examples of information included in the second request information include a “preparer” of document data that a user wants to use, a “face image” included in picture data that a user wants to use, a “movement range of subject” included in picture data that a user wants to use, and the like. Note, however, that the information included in the second request information is not limited to these examples.

### (First Condition)

The first condition is a condition which can be satisfied by the first provision information and the first request information. The first condition is a condition for determining whether or not the first provision information and the first request information match. The term “match(ing)” includes, for example, a case where the first provision information at least partially conforms to the first request information, a case where the first provision information is at least partially similar to the first request information, a case where a range indicated by at least a part of one of the first provision information and the first request information encompasses a range indicated by at least a part of the other, and the like. Examples of the first condition include cases where “classifications match”, “colors of subjects are similar”, a “range of date and time indicated by one encompasses a date and time indicated by the other”, and the like. Note, however, that the first condition is not limited to these examples.

### (Second Condition)

The second condition is a condition which can be satisfied by the second provision information and the second request information. The second condition is a condition for determining whether or not the second provision information and the second request information match. The term “match(ing)” includes, for example, a case where the second provision information at least partially conforms to the second request information, a case where the second provision information is at least partially similar to the second request information, a case where a range indicated by at least a part of one of the second provision information and the second request information encompasses a range indicated by at least a part of the other, and the like. Examples of the second condition include cases were “preparers match”, “face images are similar”, a “movement range of one subject encompasses a movement range of the other subject”, and the like. Note, however, that the second condition is not limited to these examples.

### (Provision Apparatus)

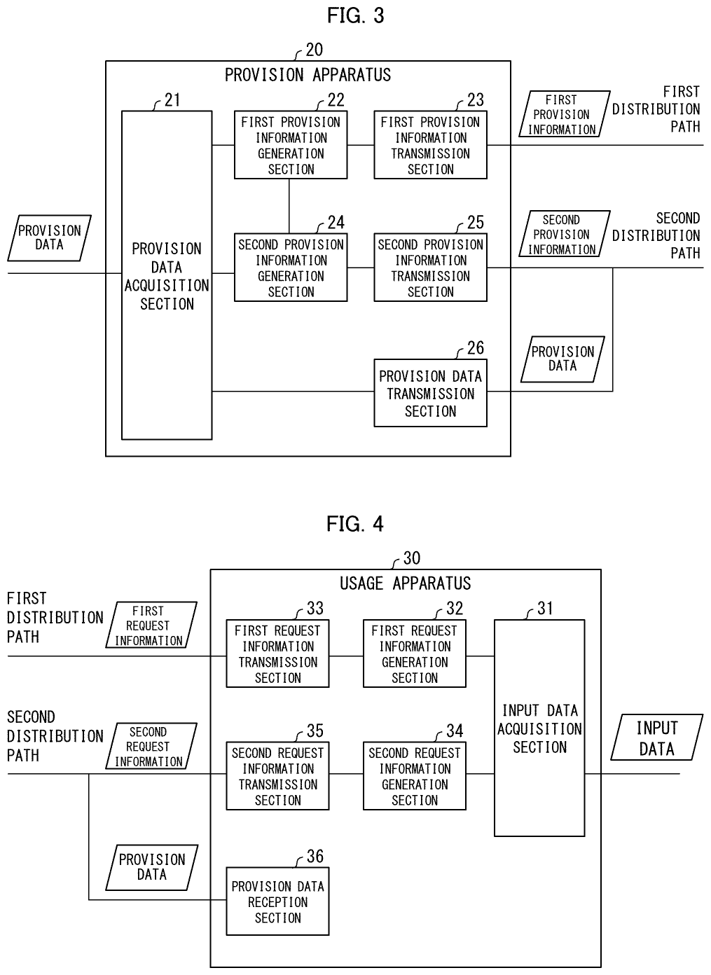

The following description will discuss the configuration of the provision apparatus 20 with reference to FIG. 3. FIG. 3 is a block diagram illustrating the configuration of the provision apparatus 20. As illustrated in FIG. 3, the provision apparatus 20 includes a provision data acquisition section 21, a first provision information generation section 22, a first provision information transmission section 23, a second provision information generation section 24, a second provision information transmission section 25, and a provision data transmission section 26. The provision data acquisition section 21 is an example configuration for realizing the provision data acquisition means recited in claims. The first provision information generation section 22 is an example configuration for realizing the first provision information generation means recited in claims. The first provision information transmission section 23 is an example configuration for realizing the first provision information transmission means recited in claims. The second provision information generation section 24 is an example configuration for realizing the second provision information generation means recited in claims. The second provision information transmission section 25 is an example configuration for realizing the second provision information transmission means recited in claims. The provision data transmission section 26 is an example configuration for realizing the provision data transmission means recited in claims.

The provision data acquisition section 21 acquires provision data.

The first provision information generation section 22 generates first provision information based on the provision data.

The first provision information transmission section 23 transmits the first provision information to the data distribution apparatus 10 via the first distribution path.

Upon receipt of notification for prompting connection to the second distribution path, the second provision information generation section 24 generates second provision information based on the provision data.

The second provision information transmission section 25 transmits the second provision information to the data distribution apparatus 10 via the second distribution path.

Upon receipt of notification for prompting provision of provision data, the provision data transmission section 26 transmits the provision data to the usage apparatus 30 via the second distribution path.

### (Usage Apparatus)

The following description will discuss a configuration of the usage apparatus 30, with reference to FIG. 4. FIG. 4 is a block diagram illustrating the configuration of the usage apparatus 30. As illustrated in FIG. 4, the usage apparatus 30 includes an input data acquisition section 31, a first request information generation section 32, a first request information transmission section 33, a second request information generation section 34, a second request information transmission section 35, and a provision data reception section 36. The input data acquisition section 31 is an example configuration for realizing the input data acquisition means recited in claims. The first request information generation section 32 is an example configuration for realizing the first request information generation means recited in claims. The first request information transmission section 33 is an example configuration for realizing the first request information transmission means recited in claims. The second request information generation section 34 is an example configuration for realizing the second request information generation means recited in claims. The second request information transmission section 35 is an example configuration for realizing the second request information transmission means recited in claims. The provision data reception section 36 is an example configuration for realizing the provision data reception means recited in claims.

The input data acquisition section 31 acquires input data indicating a request related to provision data. Details of the input data will be described later.

The first request information generation section 32 generates first request information based on the input data.

The first request information transmission section 33 transmits the first request information to the data distribution apparatus 10 via the first distribution path.

The second request information generation section 34 generates second request information based on the input data upon receipt of notification for prompting connection to the second distribution path.

The second request information transmission section 35 transmits the second request information to the data distribution apparatus 10 via the second distribution path.

The provision data reception section 36 receives the provision data from the provision apparatus 20 via the second distribution path.

### <Flow of Information Processing Method Carried Out by Data Distribution System>

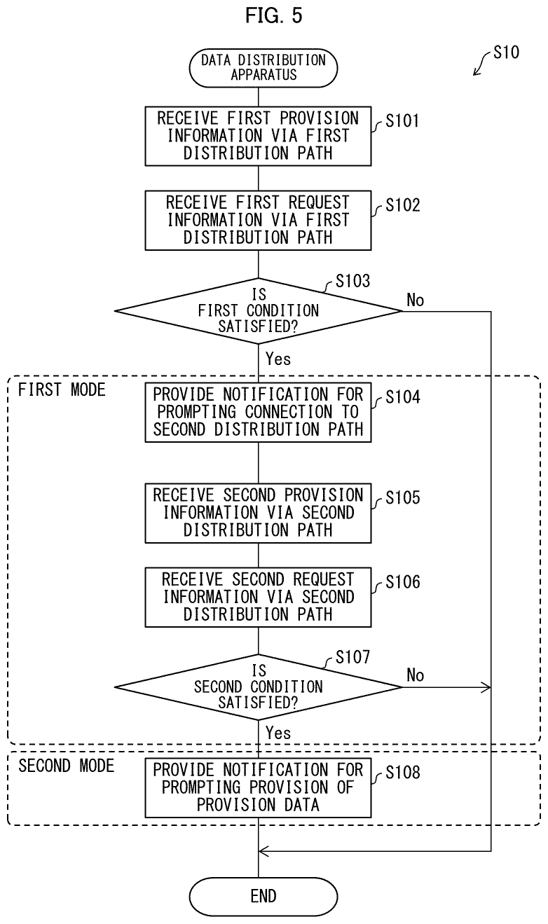

The following description will discuss a flow of an information processing method that is carried out by the data distribution system 1 configured as described above, with reference to FIGS. 5 through 7. The information processing method that is carried out by the data distribution system 1 includes a data distribution method S10, a data provision method S20, and a data usage method S30. Hereinafter, in order to make the descriptions simple, it is assumed that the number of provision data that is providable by the provision apparatus 20 is one. Moreover, it is assumed that the usage apparatus 30 makes a single request. In addition, it is assumed that a single provision apparatus 20 and a single usage apparatus 30 are provided. Note that a “case where a plurality of pieces of provision data and a plurality of requests are dealt with” and a “case where a plurality of provision apparatuses 20 and a plurality of usage apparatuses 30 are provided” will be described later.

### (Flow of Data Distribution Method)

FIG. 5 is a flowchart illustrating a flow of the data distribution method S10 that is carried out by the data distribution apparatus 10. As illustrated in FIG. 5, the data distribution method S10 includes steps S101 through S108.

### (Step S101)

In step S101, the first reception section 11 receives first provision information from the provision apparatus 20 via a first distribution path.

### (Step S102)

In step S102, the first reception section 11 receives first request information from the usage apparatus 30 via the first distribution path. Note that the order in which the processes in step S101 and step S102 are carried out is not limited to the above order.

### (Step S103)

The first determination section 12 determines whether or not the first provision information and the first request information satisfy a first condition.

(No in Step S103) In a case where it has been determined to be No in step S103, the data distribution apparatus 10 terminates the data distribution method S10.

### (Yes in Step S103: Step S104)

In a case where it has been determined to be Yes in step S103, the second distribution path notification section 13 provides, in step S104, the provision apparatus 20 and the usage apparatus 30 with notification for prompting the provision apparatus 20 and the usage apparatus 30 to connect to a second distribution path. For example, it is possible that the second distribution path notification section 13 acquires connection information for connecting to an existing second distribution path, and transmits the connection information to the provision apparatus 20 and the usage apparatus 30. Alternatively, for example, the second distribution path notification section 13 may establish a new second distribution path, and transmit connection information for connecting to the new second distribution path to the provision apparatus 20 and the usage apparatus 30. Thus, a state of the data distribution system 1 is shifted to a first mode.

### (Step S105)

In step S105, the second reception section 14 receives second provision information from the provision apparatus 20 via the second distribution path.

### (Step S106)

In step S106, the second reception section 14 receives second request information from the usage apparatus 30 via the second distribution path.

### (Step S107)

In step S107, the second determination section 15 determines whether or not the second provision information and the second request information satisfy a second condition.

### (No in Step S107)

In a case where it has been determined to be No in step S107, the data distribution apparatus 10 terminates the data distribution method S10.

### (Yes in Step S107: Step S108)

In a case where it has been determined to be Yes in step S107, the provision notification section 16 provides, in step S108, the provision apparatus 20 with notification for prompting the provision apparatus 20 to provide provision data to the usage apparatus 30 via the second distribution path. Thus, a state of the data distribution system 1 is shifted to a second mode.

### (Flow of Data Provision Method)

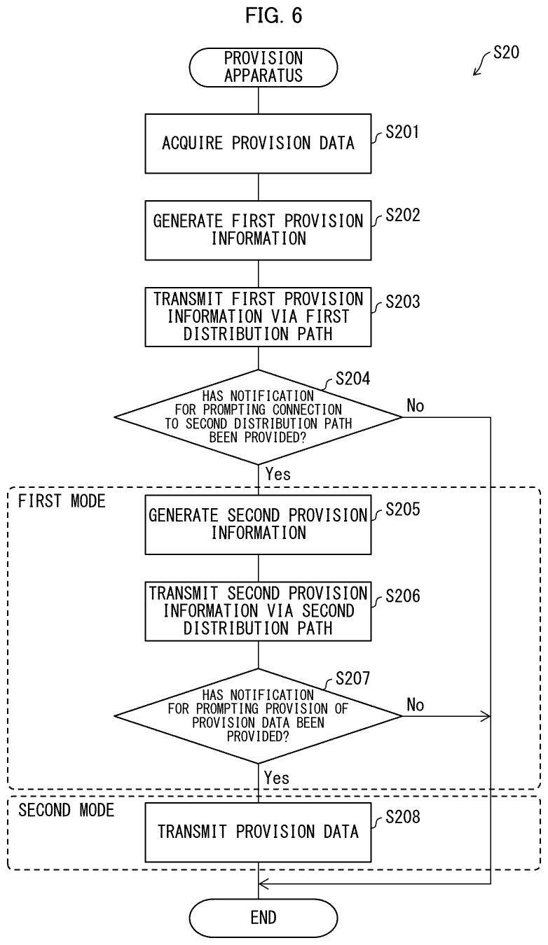

FIG. 6 is a flowchart illustrating a flow of the data provision method S20 that is carried out by the provision apparatus 20. As illustrated in FIG. 6, the data provision method S20 includes steps S201 through S208.

### (Step S201)

In step S201, the provision data acquisition section 21 acquires provision data. For example, the provision data acquisition section 21 acquires provision data from a sensor, an input apparatus, a user terminal, or the like (not illustrated).

### (Step S202)

In step S202, the first provision information generation section 22 generates first provision information based on the provision data. For example, the first provision information generation section 22 generates first provision information that includes information which is contained in or which accompanies the provision data. Alternatively, for example, the first provision information generation section 22 generates first provision information that includes information obtained by analyzing the provision data.

### (Step S203)

In step S203, the first provision information transmission section 23 transmits the first provision information to the data distribution apparatus 10 via the first distribution path.

### (Step S204)

In step S204, the second provision information generation section 24 determines whether or not notification for prompting connection to the second distribution path has been provided from the data distribution apparatus 10. In other words, the second provision information generation section 24 determines whether or not the state of the data distribution system 1 is the first mode.

### (No in Step S204)

In a case where it has been determined to be No in step S204, the provision apparatus 20 terminates the data provision method S20.

### (Yes in Step S204: Step S205)

In a case where it has been determined to be Yes in step S204, the second provision information generation section 24 generates, in step S205, second provision information based on the provision data. For example, the second provision information generation section 24 generates second provision information that includes information which is contained in or which accompanies the provision data. Alternatively, for example, the second provision information generation section 24 generates second provision information that includes information obtained by analyzing the provision data.

### (Step S206)

In step S206, the second provision information transmission section 25 transmits the second provision information to the data distribution apparatus 10 via the second distribution path.

### (Step S207)

In step S207, the provision data transmission section 26 determines whether or not notification for prompting provision of the provision data has been provided. In other words, the provision data transmission section 26 determines whether or not the state of the data distribution system 1 is the second mode. Note that steps S205 through S207 indicate operations of the provision apparatus 20 in the first mode.

### (No in Step S207)

In a case where it has been determined to be No in step S207, the provision apparatus 20 terminates the data provision method S20.

### (Yes in Step S207: Step S208)

In a case where it has been determined to be Yes in step S207, the provision apparatus 20 transmits, in step S208, provision data to the usage apparatus 30 via the second distribution path. Note that step S208 indicates an operation of the provision apparatus 20 in the second mode.

### (Flow of Data Usage Method)

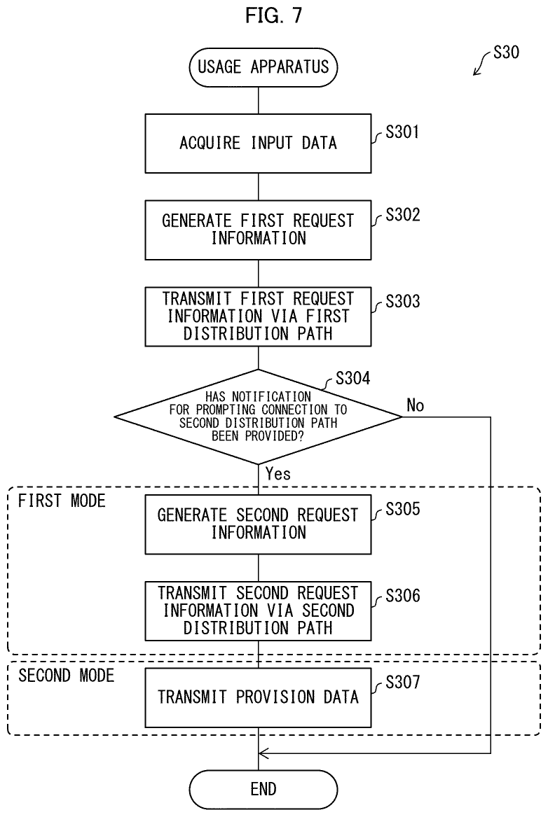

FIG. 7 is a flowchart illustrating a flow of the data usage method S30 that is carried out by the usage apparatus 30. As illustrated in FIG. 7, the data usage method S30 includes steps S301 through S307.

### (Step S301)

In step S301, the input data acquisition section 31 acquires input data. For example, the input data acquisition section 31 acquires input data from a sensor, an input apparatus, a user terminal, or the like (not illustrated). Examples of the input data includes, but not limited to, picture data, sensor data, user input information, and the like, as described above.

### (Step S302)

In step S302, the first request information generation section 32 generates first request information based on the input data. For example, the first request information generation section 32 generates first request information that includes information which is contained in or which accompanies the input data. Alternatively, for example, the first request information generation section 32 generates first request information that includes information obtained by analyzing the input data.

### (Step S303)

In step S303, the first request information transmission section 33 transmits the first request information to the data distribution apparatus 10 via the first distribution path.

### (Step S304)

In step S304, the second request information generation section 34 determines whether or not notification for prompting connection to the second distribution path has been provided. In other words, the second request information generation section 34 determines whether or not the state of the data distribution system 1 is the first mode.

### (No in Step S304)

In a case where it has been determined to be No in step S304, the usage apparatus 30 terminates the data usage method S30.

### (Yes in Step S304: Step S305)

In a case where it has been determined to be Yes in step S304, the second request information generation section 34 generates, in step S305, second request information based on the input data. For example, the second request information generation section 34 generates second request information that includes information which is contained in or which accompanies the input data. Alternatively, for example, the second request information generation section 34 generates second request information that includes information obtained by analyzing the input data.

### (Step S306)

In step S306, the second request information transmission section 35 transmits the second request information to the data distribution apparatus 10 via the second distribution path. Note that steps S305 and S306 indicate operations of the usage apparatus 30 in the first mode.

### (Step S307)

In step S307, the provision data reception section 36 receives provision data from the provision apparatus 20 via the second distribution path. Note that, in a case where it has been determined that the second condition is not satisfied in the data distribution apparatus 10, the process of this step is not carried out. In other words, the usage apparatus 30 can receive the provision data in a case where the second provision information and the second request information satisfy the second condition. Note that, when this step is carried out, the state of the data distribution system 1 is the second mode. Step S307 indicates an operation of the usage apparatus 30 in the second mode.

### <Variation 1>

The following description will discuss a variation in which a plurality of pieces of provision data and a plurality of requests are dealt with. Here, the provision apparatus 20 can provide a plurality of pieces of provision data. The usage apparatus 30 makes one or more requests related to provision data. In this case, the provision method S20, the usage method S30, and the data distribution method S10 are each modified as below.

### (Modified Point of Provision Method)

In this case, the provision apparatus 20 carries out processes of steps S201 through S203 at any point in time. In other words, the provision apparatus 20 generates first provision information in response to acquisition of provision data, and transmits the first provision information to the data distribution apparatus 10 via the first distribution path. Note that, in step S202, the first provision information generation section 22 may generate first provision information that includes information obtained by integrating a plurality of pieces of provision data.

The provision apparatus 20 carries out processes of steps S204 through S206 at any point in time. In other words, each time notification for prompting connection to the second distribution path is provided, the provision apparatus 20 generates second provision information corresponding to the first provision information, and transmits the second provision information to the data distribution apparatus 10 via the second distribution path. Note that the second distribution path can vary for each notification. Here, the second provision information corresponding to the first provision information is second provision information that is generated from the provision data which has been referred to for generating the first provision information. Note that, in step S205, the second provision information generation section 24 may generate second provision information that includes information obtained by integrating a plurality of pieces of provision data.

### (Modified Point of Usage Method)

The usage apparatus 30 carries out processes of steps S301 through S303 at any point in time. In other words, the usage apparatus 30 generates first request information in response to input of input data, and transmits the first request information to the data distribution apparatus 10 via the first distribution path. Note that, in step S302, the first request information generation section 32 may generate first request information that includes information obtained by integrating a plurality of pieces of input data.

The usage apparatus 30 carries out processes of steps S304 through S306 at any point in time. In other words, each time notification for prompting connection to the second distribution path is provided, the usage apparatus 30 generates second request information corresponding to the first request information and transmits the second request information to the data distribution apparatus 10 via the second distribution path. Note that the second distribution path can vary for each notification. Here, the second request information corresponding to the first request information is second request information that is generated from the input data which has been referred to for generating the first request information. Note that, in step S305, the second request information generation section 34 may generate second request information that includes information obtained by integrating a plurality of pieces of input data.

The data distribution apparatus 10 accumulates first provision information in a memory (not illustrated) each time the data distribution apparatus 10 receives the first provision information from the provision apparatus 20 (step S101). The data distribution apparatus 10 accumulates first request information in the memory each time the data distribution apparatus 10 receives the first request information from the usage apparatus 30 (step S102). Thus, a plurality of pieces of first provision information and a plurality of pieces of first request information are accumulated in the memory.

### (Modified Point of Data Distribution Method)

In step S103, the first determination section 12 extracts a combination of first provision information and first request information that satisfy a first condition, from among the plurality of pieces of first provision information and the plurality of pieces of first request information.

In step S104, the second distribution path notification section 13 establishes a different second distribution path in accordance with the combination of the first provision information and the first request information that satisfy the first condition. In other words, the second distribution path to be established is a dedicated distribution path corresponding to the combination. The second distribution path notification section 13 provides the provision apparatus 20 with notification for prompting the provision apparatus 20 to connect to a second distribution path, and also notification for prompting the provision apparatus 20 to transmit second provision information corresponding to first provision information that satisfies the first condition. Moreover, the second distribution path notification section 13 provides the usage apparatus 30 with notification for prompting the usage apparatus 30 to connect to the second distribution path, and also notification for prompting the usage apparatus 30 to transmit second request information corresponding to first provision information that satisfies the first condition.

The data distribution apparatus 10 accumulates a plurality of pieces of second provision information and a plurality of pieces of second request information in the memory by repeatedly carrying out steps S103 through S106.

In step S107, the data distribution apparatus 10 extracts a combination of second provision information and second request information that satisfy a second condition, from among the plurality of pieces of second provision information and the plurality of pieces of second request information.

In step S108, the data distribution apparatus 10 provides the provision apparatus 20 with notification for prompting the provision apparatus 20 to provide provision data corresponding to second provision information that satisfies the second condition. The provision data corresponding to the second provision information is provision data that has been referred to for generating the second provision information.

### <Variation 2>

The following description will discuss an information processing method carried out in a case in which the data distribution system 1 includes a plurality of provision apparatuses 20 and a plurality of usage apparatuses 30. Here, each of the provision apparatuses 20 can provide a plurality of pieces of provision data. Moreover, each of the usage apparatuses 30 makes a plurality of requests related to provision data.

The information processing method in this case is modified as below, in addition to being modified in a manner similar to that in the “information processing method carried out in a case in which a plurality of pieces of provision data and a plurality of requests are dealt with”.

In step S104, the second distribution path notification section 13 of the data distribution apparatus 10 establishes a different second distribution path in accordance with the combination of the first provision information and the first request information that satisfy the first condition. After that, the second distribution path notification section 13 provides a provision apparatus 20 from which the first provision information has been transmitted and a usage apparatus 30 from which the first request information has been transmitted with notification for prompting the provision apparatus 20 and the usage apparatus 30 to connect to the second distribution path.

In step S108, the data distribution apparatus 10 provides a provision apparatus 20 from which second provision information that satisfies a second condition has been transmitted with notification for prompting the provision apparatus 20 to provide provision data corresponding to the second provision information.

### <Variation 3>

The present example embodiment can be modified to provide provision data via a plurality of stages of condition determination in a second distribution path. In other words, in this variation, while a second distribution path is established, the state of the data distribution system 1 can be any of a first mode to an n-th mode (n is an integer of 3 or more). The first to (n-1)th modes are states in which a disclosure range of provision data is limited in stages. The n-th mode is a state in which disclosure of provision data is entirely permitted.

In this case, the second reception section 14, the second determination section 15, and the provision notification section 16 in the data distribution apparatus 10 are modified as follows.

In a case where the second determination section 15 has determined that i-th provision information and i-th request information satisfy an i-th condition, the second reception section 14 receives, for i (=2, . . . , n−1), (i+1)th provision information and (i+1)th request information via the second distribution path. Here, the (i+1)th provision information is information pertaining to the provision data, and is more specific than the i-th provision information. The (i+1)th request information is information indicating a request related to provision data that a user wants to use, and is more specific than the i-th request information.

The second determination section 15 determines whether or not the i-th provision information and the i-th request information received by the second reception section 14 satisfy the i-th condition (i=2, . . . , n). The i-th condition is a condition which can be satisfied by the i-th provision information and the i-th request information. The i-th condition is a condition for determining whether or not the i-th provision information and the i-th request information match.

In a case where an n-th condition is satisfied, the provision notification section 16 provides the provision apparatus 20 with notification for prompting the provision apparatus 20 to provide provision data to the usage apparatus 30.

### (Modified Point of Data Distribution Method)

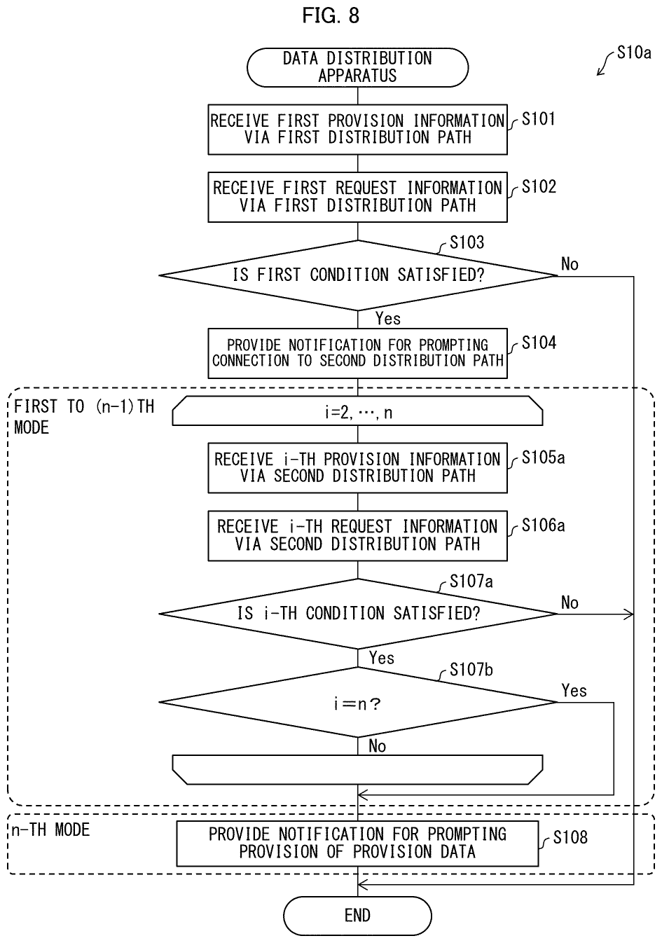

In this case, the data distribution apparatus 10 carries out a data distribution method S10a that is obtained by modifying the data distribution method S10. The following description will discuss the data distribution method S10a with reference to FIG. 8. FIG. 8 is a flowchart illustrating a flow of the data distribution method S10a. As illustrated in FIG. 8, the data distribution method S10a is different from the data distribution method S10 illustrated in FIG. 5 in that, instead of steps S105 through S107, steps S105a through S107a and

S107b are repeated for i=2, . . . , n.

### (Step S105a)

In step S105a, the second reception section 14 receives i-th provision information by providing the provision apparatus 20 with notification for prompting the provision apparatus 20 to transmit the i-th provision information via the second distribution path.

### (Step S106a)

In step S106a, the second reception section 14 receives i-th request information by providing the usage apparatus 30 with notification for prompting the usage apparatus 30 to transmit the i-th request information via the second distribution path.

### (Step S107a)

In step S107a, the second determination section 15 determines whether or not the i-th provision information and the i-th request information satisfy an i-th condition.

### (No in Step S107a)

In a case where it has been determined to be No in step S107, the data distribution apparatus 10 terminates the data distribution method S10.

(Yes in Step S107a: Step S107b) In a case where it has been determined to be Yes in step S107a, the state of the data distribution system 1 is shifted to an (i+1)th mode. In step S107b, the second determination section 15 determines whether or not i=n.

### (No in Step S107b)

In a case where it has been determined to be No in step S107b, the second determination section 15 adds 1 to i and repeats the processes from step S105a.

### (Yes in Step S107b: Step S108)

In a case where it has been determined to be Yes in step S107b, the state of the data distribution system 1 is shifted to an n-th mode. Then, the provision notification section 16 provides, in step S108, the provision apparatus 20 with notification for prompting the provision apparatus 20 to provide provision data to the usage apparatus 30 via the second distribution path.

In this case, the provision apparatus 20 carries out steps S205 and S206 of the provision method S20 with the following modifications.

### (Modified Point of Provision Method)

Upon receipt of notification for prompting transmission of i-th provision information from the data distribution apparatus 10, the provision apparatus 20 generates the i-th provision information in step S205 and transmits the i-th provision information in step S206.

### (Modified Point of Usage Method)

Upon receipt of notification for prompting transmission of i-th request information from the data distribution apparatus 10, the usage apparatus 30 generates the i-th request information in step S305 and transmits the i-th request information in step S306.

Note that the data distribution system 1 may have a function of prohibiting transmission and reception of information more specific than a prescribed level of detail for the first distribution path and each mode of the second distribution path. For example, it is possible to employ a configuration in which the data distribution apparatus 10 relays information transmitted via the first distribution path and the second distribution path and, in a case where the transmitted information is more specific than a prescribed level of detail, the data distribution apparatus 10 discards the information and does not relay the information.

### Effect of the Present Example Embodiment

The present example embodiment and the variations can more reliably provide data that is demanded by a user, while enhancing security. The reason is that provision data is provided in a case where schematic first provision information and first request information which are transmitted and received via the first distribution path satisfy a first condition, and in addition, detailed second provision information and second request information which are transmitted and received via the private second distribution path satisfy a second condition. This increases reliability that provided data is data demanded by a user, as compared with a case where provision data is provided when only a first condition is satisfied. In other words, a possibility that provided data is data which is not demanded by a user decreases. As a result, the present example embodiment can reduce a possibility of information leakage due to provision of data which is not demanded by a user, and security is enhanced.

### Second Example Embodiment

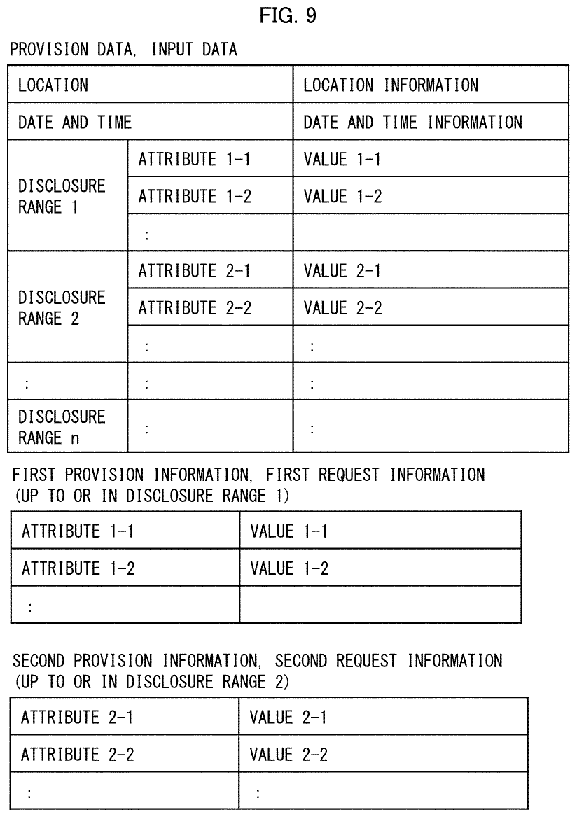

As a second example embodiment of the present invention, the following description will discuss an example of a data structure that is suitably used by the data distribution system 1 according to the first example embodiment, with reference to FIG. 9. FIG. 9 is a block diagram illustrating an example of data structures of provision data, input data, first provision information, first request information, second provision information, and second request information.

### (Data Structure of Provision Data and Input Data)

As illustrated in FIG. 9, the provision data and the input data have the same data structure. The provision data and the input data include attributes “location” and “date and time”, and one or more other attributes. Each of the attributes is associated with information indicating a disclosure range i (i=1, . . . , n: n is an integer of 3 or more). The attributes are each constituted by identification information of that attribute (key: attribute 1-1, 1-2, . . . , 2-1, 2-2, . . . , n−1, n-2, . . . ) and a value (value: value 1-1, 1-2, . . . , 2-1, 2-2, . . . , n−1, n-2, . . . ). Hereinafter, an attribute constituted by a key “attribute X-X” and a value “value X-X” may be simply referred to as “attribute X-X”.

### (Location)

The attribute “location” represents a location related to provision data or input data. For example, the attribute “location” is, but not limited to, information indicating a place where the data was generated or a place where the data was acquired.

### (Date and Time)

The attribute “date and time” represents a date and time related to provision data or input data. For example, the attribute “date and time” is, but not limited to, information indicating a date and time at which the data was generated or a date and time at which the data was acquired.

### (Disclosure Range)

The disclosure range i is information indicating a level of detail. In this example, as i increases, the disclosure range i is more specific. In other words, as i increases, the disclosure range i indicates higher confidentiality. An attribute that is associated with a disclosure range 1 is permitted to be transmitted and received through the first distribution path. An attribute that is associated with a disclosure range i where i is 2 or more is not permitted to be transmitted and received through the first distribution path, and is permitted to be transmitted and received through the second distribution path in a case where an [i-1]th condition is satisfied. Note that an attribute that is associated with a disclosure range n is actual data that is ultimately permitted to be transmitted and received in a case where an [n-1]th condition is satisfied. In the example of FIG. 9, the attributes “location” and “date and time” are not associated with a disclosure range i. Note, however, that a disclosure range i may be associated with one of or both of those attributes.

The provision data does not necessarily need to include information itself that indicates a disclosure range i. Specifically, it is possible to associate each attribute with a disclosure range by preparing information which is different from the provision data and in which a key of an attribute is associated with a disclosure range i.

The provision data or the input data does not necessarily need to include all attributes which are associated with each of disclosure ranges 1 through n. For example, provision data only needs to include at least a “location”, a “date and time”, and “actual data” that is associated with a disclosure range n. In this case, an attribute of a disclosure range 1 to be included in first provision information may be generated by the first provision information generation section 22 of the provision apparatus 20 based on the provision data. Moreover, an attribute of a disclosure range 2 to be included in second provision information may be generated by the second provision information generation section 24 of the provision apparatus 20 based on the provision data.

For example, the input data does not necessarily need to include “actual data” that is associated with a disclosure range n. For example, in a case where input data includes attributes which are respectively associated with the disclosure range 1 and the disclosure range 2, first request information and second request information can be generated even if the input data does not include an attribute associated with the disclosure range n.

### (Data Structure of First Provision Information and First Request Information)

As illustrated in FIG. 9, the first provision information and the first request information have the same data structure. The first provision information and the first request information each include an attribute 1-1, an attribute 1-2, and so forth. These attributes included in the first provision information are attributes that are contained in the provision data or generated based on the provision data, and that are associated with a disclosure range of 1 or less. These attributes included in the first request information are attributes that are contained in the input data or generated based on the input data, and that are associated with the disclosure range of 1 or less.

### (Data Structure of Second Provision Information and Second Request Information)

As illustrated in FIG. 9, the second provision information and the second request information have the same data structure. The second provision information and the second request information each include an attribute 2-1, an attribute 2-2, and so forth. These attributes included in the second provision information are attributes that are contained in the provision data or generated based on the provision data, and that are associated with a disclosure range of 2 or less. These attributes included in the second request information are attributes that are contained in the input data or generated based on the input data, and that are associated with the disclosure range of 2 or less.

### <Flow of Information Processing Method Carried Out by Data Distribution System>

By using the data structure illustrated in FIG. 9, specific operations in the information processing method (the data distribution method, the data provision method, and the data usage method) described with reference to FIGS. 5 through 7 will be as described below. Note that steps other than those described below are as described above. Therefore, the descriptions of such steps are not repeated.

### (Specific Operations in Data Distribution Method)

### (Step S103)

In step S103, the first determination section 12 of the data distribution apparatus 10 determines whether or not each combination of corresponding attributes included in the first provision information and the first request information satisfies a first condition. A combination of corresponding attributes is predetermined in a manner in which, for example, an attribute 1-1 included in the first provision information and an attribute 1-1 included in the first request information correspond to each other. In a case where the first condition is satisfied, the process of step S104 is carried out.

### (Step S107)

In step S107, the second determination section 15 of the data distribution apparatus 10 determines whether or not each combination of corresponding attributes included in the second provision information and the second request information satisfies a second condition. A combination of corresponding attributes is predetermined in a manner in which, for example, an attribute 2-1 included in the second provision information and an attribute 2-1 included in the second request information correspond to each other. In a case where the second condition is satisfied, the process of step S108 is carried out.

### (Specific Operations in Data Provision Method)

### (Step S202)

In step S202, the first provision information generation section 22 of the provision apparatus 20 refers to the provision data, acquires an attribute associated with the disclosure range 1, and generates first provision information that includes the acquired attribute. For example, the first provision information generation section 22 may acquire an attribute 1-1, an attribute 1-2, and so forth which are associated with the disclosure range 1 and are included in the provision data. Alternatively, for example, the first provision information generation section 22 may generate, by analyzing the provision data, an attribute 1-1, an attribute 1-2, and so forth which are associated with the disclosure range 1. Alternatively, for example, the first provision information generation section 22 may generate, based on a plurality of pieces of provision data, an attribute 1-1, an attribute 1-2, and so forth which are associated with the disclosure range 1.

### (Step S205)

In step S205, the second provision information generation section 24 of the provision apparatus 20 refers to the provision data, acquires an attribute associated with the disclosure range of 2 or less, and generates second provision information that includes the acquired attribute. For example, the second provision information generation section 24 may acquire an attribute 2-1, an attribute 2-2, and so forth which are associated with the disclosure range 2 and are included in the acquired provision data. Alternatively, for example, the second provision information generation section 24 may generate, by analyzing the acquired provision data, an attribute 2-1, an attribute 2-2, and so forth that are associated with the disclosure range 2. Alternatively, for example, the second provision information generation section 24 may generate, based on a plurality of pieces of provision data, an attribute 2-1, an attribute 2-2, and so forth that are associated with the disclosure range 2.

### (Specific Operations in Data Usage Method)

### (Step S302)

In step S302, the first request information generation section 32 of the usage apparatus 30 acquires, with reference to input data, an attribute associated with the disclosure range 1. The first request information generation section 32 generates first request information that includes the acquired attribute. For example, the first request information generation section 32 may acquire an attribute 1-1, an attribute 1-2, and so forth which are associated with the disclosure range 1 and are included in the input data itself. Alternatively, for example, the first request information generation section 32 may generate, by analyzing the input data, an attribute 1-1, an attribute 1-2, and so forth which are associated with the disclosure range 1. Alternatively, for example, the first request information generation section 32 may generate, based on a plurality of pieces of input data, an attribute 1-1, an attribute 1-2, and so forth which are associated with the disclosure range 1.

### (Step S305)

In step S305, the second request information generation section 34 of the usage apparatus 30 refers to the input data, acquires an attribute associated with the disclosure range of 2 or less, and generates second request information that includes the acquired attribute. For example, the second request information generation section 34 may acquire an attribute 2-1, an attribute 2-2, and so forth which are associated with the disclosure range 2 and are included in the input data. Alternatively, for example, the second request information generation section 34 may generate, by analyzing the input data, an attribute 2-1, an attribute 2-2, and so forth which are associated with the disclosure range 2. Alternatively, for example, the second request information generation section 34 may generate, based on a plurality of pieces of input data, an attribute 2-1, an attribute 2-2, and so forth which are associated with the disclosure range 2.

### Effect of the Present Example Embodiment

The data distribution system 1 brings about an effect that, even in a case where there are a wide variety of types of provision data or a wide variety of types of requests, the data distribution system 1 can operate versatilely by using the data structure of the present example embodiment.

### Third Example Embodiment

The following description will discuss a third example embodiment of the present invention in detail with reference to the drawings. The third example embodiment is an example aspect which is obtained by altering the data distribution system 1 according to the first example embodiment so as to be applied to a guard dispatch system. In the present example embodiment, provision data, input data, first provision information, second provision information, first request information, and second request information which have the data structures according to the second example embodiment are used. The same reference numerals are given to constituent elements which have functions identical with those described in the first and second example embodiments, and descriptions as to such constituent elements are not repeated.

### Configuration of Data Distribution System

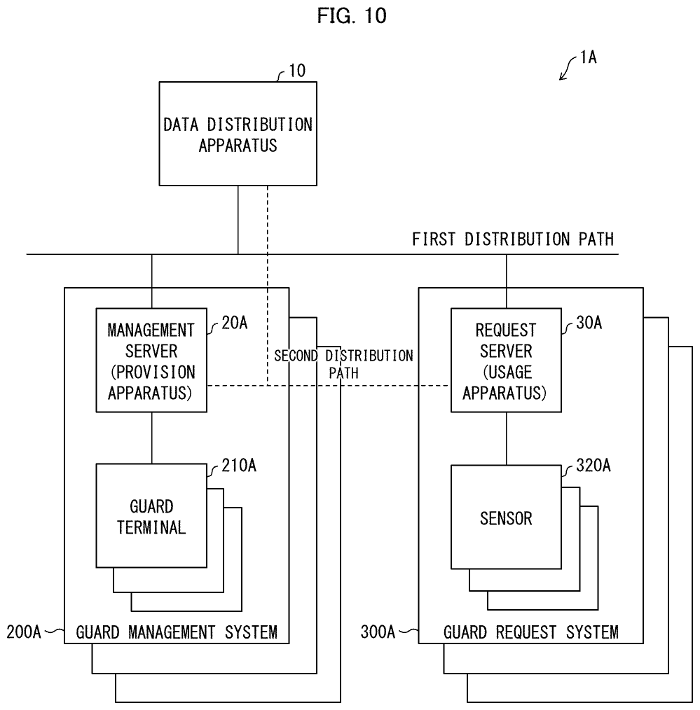

The following description will discuss a configuration of a data distribution system 1A according to the present example embodiment, with reference to FIG. 10. FIG. 10 is a block diagram illustrating the configuration of the data distribution system 1A. As illustrated in FIG. 10, the data distribution system 1A includes a data distribution apparatus 10, one or more guard management systems 200A, and one or more guard request systems 300A. The guard management system 200A includes a management server 20A and one or more guard terminals 210A. The guard request system 300A includes a request server 30A and one or more sensors 310A.

The data distribution system 1A is a communication system of publish/subscribe type model. In the data distribution system 1A, guard information pertaining to a guard who can be dispatched is provided from the guard management system 200A to the guard request system 300A under control of the data distribution apparatus 10.

The data distribution apparatus 10, the management server 20A, and the request server 30A are communicably connected to each other via a first distribution path while the data distribution system 1A is operating. The data distribution apparatus 10, the management server 20A, and the request server 30A can be communicably connected to each other temporarily via a second distribution path. In FIG. 10, three guard management systems 200A and three guard terminals 210A are illustrated. However, the number of guard management systems 200A included in the data distribution system 1A and the number of guard terminals 210A included in each of the guard management systems 200A are not limited to three. In FIG. 10, three guard request systems 300A and three sensors 310A are illustrated. However, the number of guard request systems 300A included in the data distribution system 1A and the number of sensors 310A included in each of the guard request systems 300A are not limited to three.

### (Configuration of Management Server)

The management server 20A is an example configuration for realizing the “provision apparatus” recited in claims. The management server 20A is configured in a manner substantially similar to the provision apparatus 20 according to the first example embodiment, but is different at least in that the management server 20A is communicably connected to the guard terminal 210A and that the management server 20A provides guard information as provision data.

The management server 20A and each of the guard terminals 210A are connected to each other by a network. For example, the network is constituted by, but not limited to, a wireless LAN, a wired LAN, a WAN, mobile data communication, or a combination of at least two of these.

The management server 20A generates guard information based on a current location and personal information acquired from the guard terminal 210A. The management server 20A may receive a current location and personal information by periodically making requests to the guard terminal 210A. Alternatively, the management server 20A may receive a current location and personal information which are periodically transmitted from the guard terminal 210A.

The management server 20A, based on the guard information, generates available guard information as first provision information, and generates detailed available guard information as second provision information.

### (Configuration of Guard Terminal)

The guard terminal 210A is constituted by a computer which is portable for a guard. Examples of the guard terminal 210A include, but not limited to, a smart phone, a tablet, and the like. The guard terminal 210A has a processor, a memory, a communication interface, and a global positioning system (GPS) receiver. The guard terminal 210A transmits personal information of a guard stored in the memory to the management server 20A via the communication interface by executing a program stored in the memory by the processor. The guard terminal 210A transmits a current location calculated using the GPS receiver to the management server 20A via the communication interface. The guard terminal 210A may periodically transmit personal information and a current location, or may transmit personal information and a current location in response to periodic requests from the management server 20A.

### (Configuration of Request Server)

The request server 30A is an example configuration for realizing the “usage apparatus” recited in claims. The request server 30A is configured in a manner substantially similar to the usage apparatus 30 according to the first example embodiment, but is different at least in that the request server 30A is communicably connected to the sensor 310A and that the request server 30A acquires a sensor value as input data.

The request server 30A and each of the sensors 310A are connected to each other by a network. Examples of the network include, but not limited to, serial communication, a wireless LAN, a wired LAN, a WAN, mobile data communication, and a combination of at least two of these.

The request server 30A may receive a sensor value by periodically requesting the sensor value from the sensor 310A, or may receive a sensor value which is periodically transmitted from the sensor 310A.

The request server 30A generates, from the sensor value, dispatch request information as first request information, and detailed dispatch request information as second request information.

### (Configuration of Sensor)

The sensor 310A is a sensor for detecting a degree of crowdedness. Examples of the sensor 310A include, but not limited to, a camera, an infrared sensor, a sensor that detects a concentration of carbon dioxide, and the like. The sensor 310A transmits a measured sensor value to the request server 30A. The sensor 310A may transmit a sensor value that has been periodically measured to the request server 30A, or may transmit a sensor value that has been measured in response to periodic requests from the request server 30A.

For example, in a case where the sensor 310A is a camera, the sensor 310A includes a light collecting lens, an imaging element, a processor, a memory, and a communication interface. By executing a program stored in the memory by the processor, the sensor 310A converts light received via the light collecting lens into an electric signal by the imaging element. Then, the sensor 310A carries out A/D conversion of the electric signal for image processing to generate picture data. The sensor 310A transmits the generated picture data, a current date and time, and information indicating an installation location stored in the memory to the request server 30A via the communication interface.

### (Provision Data: Guard Information)

The guard information is an example of the “provision data” recited in claims, and is data that can be provided by the management server 20A. The guard information is information pertaining to a guard that holds the guard terminal 210A, and is information indicating a resource (guard) that can be dispatched by the guard management system 200A.

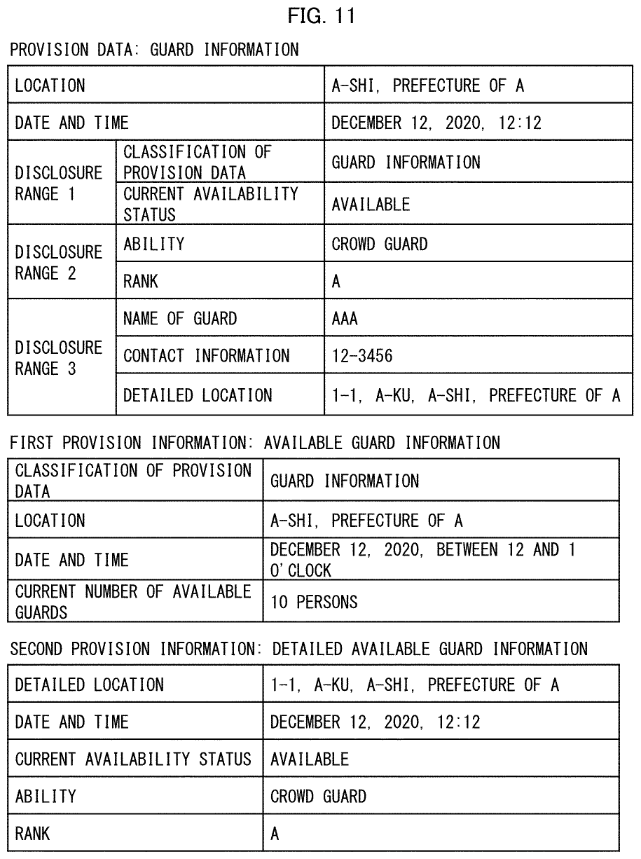

The following description will discuss a data structure of guard information, with reference to FIG. 11. FIG. 11 is a diagram illustrating an example of data structures of guard information, available guard information, and detailed available guard information. As illustrated in FIG. 11, the guard information includes attributes “location” and “date and time”. The “location” is an attribute that indicates a current location of the guard in terms of wide area. In this example, the attribute indicating a current location in terms of wide area is, but not limited to, information indicating an address up to a city, town or village. For example, the attribute indicating a current location in terms of wide area may be information that specifies a separately defined zone.

The guard information includes “classification of provision data” and “current availability status” as attributes which are associated with a disclosure range 1. In this example, the “classification of provision data” is “guard information”. Moreover, the “current availability status” is “available”.

Moreover, the guard information includes an “ability” and a “rank” as attributes which are associated with a disclosure range 2. In this example, the “ability” is “crowd guard”. Other examples of the “ability” include, but not limited to, “facility guard”, “evacuation guidance”, and the like. Moreover, the “rank” is “A”. Other examples of the “rank” include “B”, “C”, and the like, where the rank is assumed to decrease in order of A, B, and C. Note, however, that the rank is not limited to this example. In this example, it is assumed that a rank of capability is determined in accordance with a degree of crowdedness of a request source.

The guard information includes a “name of guard”, “contact information” and a “detailed location” as attributes which are associated with a disclosure range 3. The “detailed location” is information indicating a current location of the guard in terms of narrow area. In this example, the information indicating a current position in terms of narrow area is, but not limited to, information indicating a detailed address. For example, information indicating a current location in terms of narrow area may be information including latitude and longitude.

### (First Provision Information: Available Guard Information)

The available guard information is an example of the “first provision information” recited in claims. The available guard information is generated by integrating a plurality of pieces of guard information. The following description will discuss available guard information generated from a plurality of pieces of guard information, with reference to FIG. 11. As illustrated in FIG. 11, the available guard information includes “guard information” as the attribute “classification of provision data”. The available guard information includes “A-shi, Prefecture of A” as the attribute “location”. The available guard information includes “Dec. 12, 2020, between 12 and 1 o'clock” as the attribute “date and time”. The available guard information includes “10 persons” as the attribute “current number of available guards”. These attributes are generated by integration of ten pieces of guard information for each of which the “classification of provision data” is “guard information”, the “location” is “A-shi, Prefecture of A”, the “date and time” is “Dec. 12, 2020, between 12 and 1 o'clock”, and the “current availability status” is “available”. Note that it is predetermined that a disclosure range 1 is associated with these attributes that are generated by integration.

### (Second Provision Information: Detailed Available Guard Information)

The detailed available guard information is an example of the “second provision information” recited in claims. The detailed available guard information is generated from individual guard information. The following description will discuss the detailed available guard information with reference to FIG. 11. As illustrated in FIG. 11, the detailed available guard information includes attributes “detailed location”, “date and time”, “current availability status”, “ability”, and “rank”. These attributes are included in guard information. Moreover, these attributes are associated with a disclosure range 2.

### (Sensor Value)

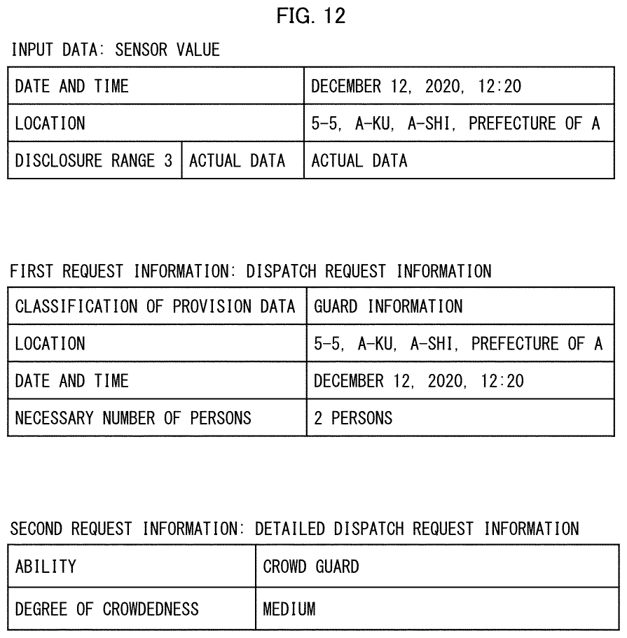

The sensor value is an example of the “input data” recited in claims, and is information indicating a request by the request server 30A. The following description will discuss the sensor value with reference to FIG. 12. FIG. 12 is a diagram illustrating an example of data structures of a sensor value, dispatch request information, and detailed dispatch request information. As illustrated in FIG. 12, the sensor value includes a “date and time”, a “location”, and “actual data”. The “date and time” is a date and time at which the sensor value was measured. The “location” is a location at which the sensor 310A is installed. The “actual data” is a measured value.

### (First Request Information: Dispatch Request Information)

The dispatch request information is an example of the “first request information” recited in claims. The dispatch request information is generated from a sensor value which is input data. The following description will discuss the dispatch request information with reference to FIG. 12. As illustrated in FIG. 12, the dispatch request information includes attributes “location”, “date and time”, “classification of provision data”, and “necessary number of persons”. Each of the attributes is an attribute that is associated with a disclosure range 1 and that is possessed by guard information that a user wants to use.

Specifically, the dispatch request information indicates a request for using information for which the “classification of provision data” is “guard information”. In the present example embodiment, it is predetermined to include “guard information” as the attribute “classification of provision data” in the dispatch request information. This dispatch request information indicates a request for using guard information for which the attribute “location” is near to “5-5, A-ku, A-shi, Prefecture of A”. This attribute is generated from the attribute “location” that is possessed by the sensor value. Moreover, this dispatch request information indicates a request for using guard information for which the attribute “date and time” is near to “Dec. 12, 2020, 12:20”. This attribute is generated from the attribute “date and time” included in the sensor value. For this dispatch request information, the “necessary number of persons” is “2 persons”. Therefore, the dispatch request information indicates a request for using guard information for which the attribute “current number of available guard” is “2 persons” or more. Note that the attribute “necessary number of persons” is a value corresponding to a degree of crowdedness that is a result of analyzing a sensor value (e.g., picture data). Moreover, it is predetermined that the attribute “necessary number of persons” included in dispatch request information and the attribute “current number of available guards” included in available guard information are attributes which correspond to each other.

### (Second Request Information: Detailed Dispatch Request Information)

The detailed dispatch request information is an example of the “second request information” recited in claims. The detailed dispatch request information is generated from the sensor value that is the input data. The following description will discuss detailed dispatch request information generated from the sensor value, with reference to FIG. 12. As illustrated in FIG. 12, the detailed dispatch request information will be described with reference to FIG. 12 for the detailed dispatch request information. As illustrated in FIG. 12, the detailed dispatch request information includes attributes “ability” and “degree of crowdedness”. Each of the attributes is an attribute that is associated with a disclosure range 2 and that is possessed by guard information that a user wants to use.

Specifically, the detailed dispatch request information indicates a request for using guard information for which the attribute “ability” is “crowd guard”. In the present example embodiment, it is predetermined to include “crowd guard” as the attribute “ability” in the detailed dispatch request information. For the detailed dispatch request information, the attribute “degree of crowdedness” is approximately “medium”. Therefore, the detailed dispatch request information indicates a request for using guard information for which the “rank” is “B” or higher. Note that the attribute “degree of crowdedness” is a value corresponding to a degree of crowdedness that is a result of analyzing a sensor value (e.g., picture data). For example, the attribute “degree of crowdedness” takes a value of one of “large”, “medium”, and “small”. Moreover, it is predetermined that the attribute “degree of crowdedness” included in detailed dispatch request information and the attribute “rank” included in detailed available guard information are attributes which correspond to each other. Moreover, it is predetermined that, in a case where the “degree of crowdedness” is approximately “medium”, the “rank” of “B” or higher is necessary.

### <Flow of Information Processing Method>

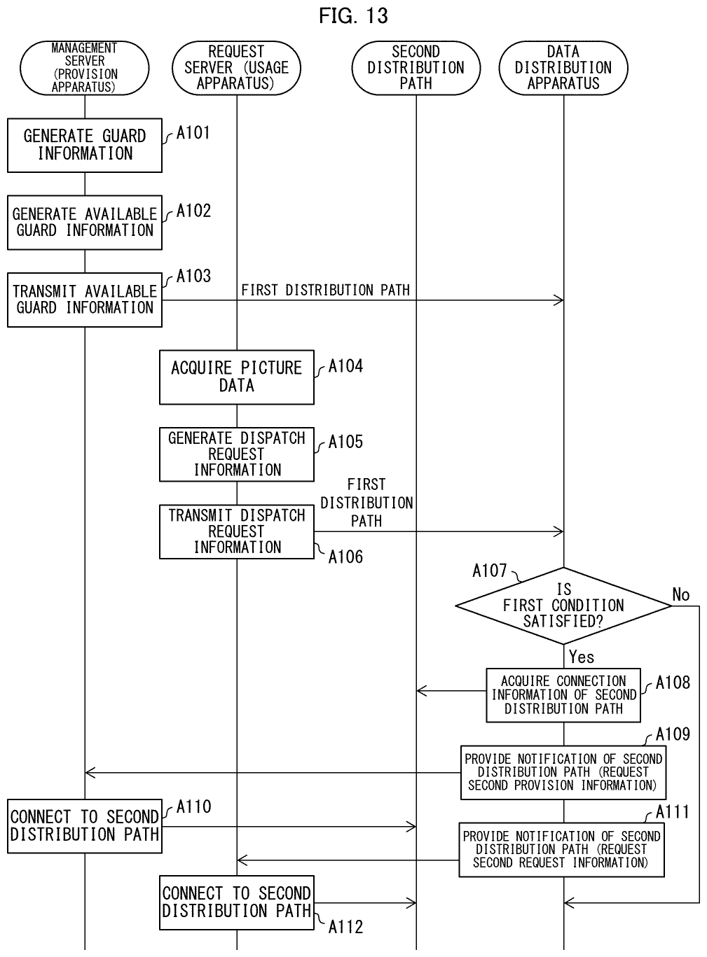

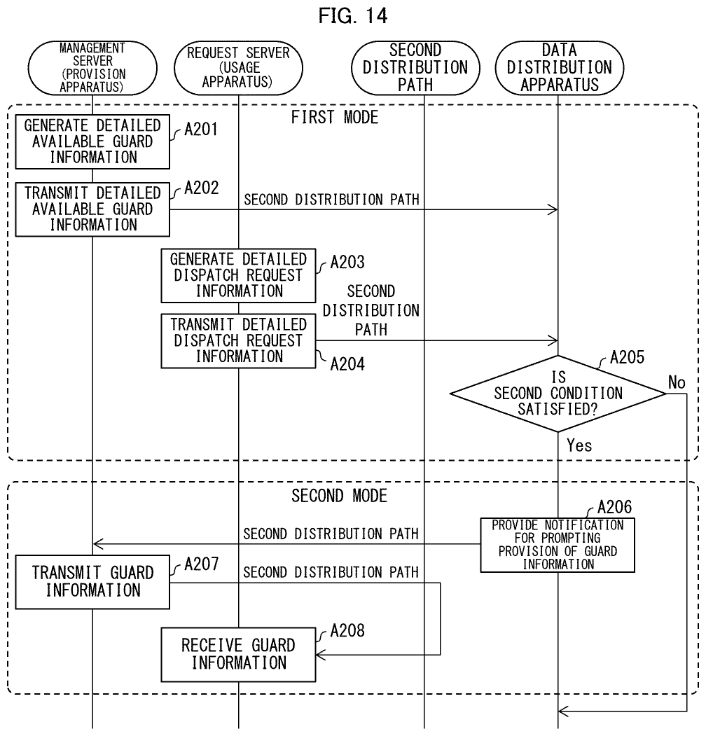

Next, the following description will discuss a flow of an information processing method S1A that is carried out by the data distribution system 1A, with reference to FIGS. 13 and 14. FIG. 13 is a sequence diagram illustrating the flow of the information processing method S1A. FIG. 14 is a sequence diagram continued from FIG. 13. The information processing method S1A is carried out when the data distribution apparatus 10, the management server 20A, and the request server 30A carry out the data distribution method S10, the data provision method S20, and the data usage method S30, respectively.

As illustrated in FIGS. 13 and 14, the information processing method S1A includes steps A101 through A112, and includes steps A201 through A208 which are carried out after establishment of a second distribution path. After the second distribution path is established, there are a first mode (steps A201 through A205) in which a disclosure range of provision data is limited, and a second mode (steps A206 through A208) in which a disclosure range of provision data is not limited.

### (Step A101)

In step A101, the provision data acquisition section 21 of the management server 20A generates guard information, which is provision data, based on a current location and personal information which have been acquired from the guard terminal 210A. The guard information that is generated is as described above with reference to FIG. 11.

### (Step A102)

In step A102, the first provision information generation section 22 generates available guard information based on a plurality of pieces of guard information. The available guard information that is generated is as described above with reference to FIG. 11. For example, the first provision information generation section 22 calculates the number of pieces of guard information for which the attribute “current availability information” is “available” as the number of available guards, from among a plurality of pieces of guard information for which the attributes “location” and “date and time” satisfy a predetermined condition. Then, the calculated number of available guards is included in the available guard information.

### (Step A103)

In step A103, the first provision information transmission section 23 transmits the available guard information to the data distribution apparatus 10 via the first distribution path. The first reception section 11 of the data distribution apparatus 10 receives the available guard information and accumulates the available guard information in the memory. The processes of steps A101 through A103 are repeatedly carried out at any point in time.

### (Step A104)

In step A104, the input data acquisition section 31 of the request server 30A acquires a sensor value from the sensor 310A. The sensor value that is acquired is as described above with reference to FIG. 12. In this example, it is assumed that picture data is acquired from the sensor 310A which is a camera.

### (Step A105)

In step A105, the first request information generation section 32 generates dispatch request information based on the picture data. The dispatch request information that is generated is as described above with reference to FIG. 12. For example, the first request information generation section 32 calculates the necessary number of guards based on the degree of crowdedness which has been obtained by analyzing the picture data by artificial intelligence (AI), and includes the necessary number of guards in the dispatch request information.

### (Step A106)

In step A106, the first request information transmission section 33 transmits the dispatch request information to the data distribution apparatus 10 via the first distribution path. The first reception section 11 of the data distribution apparatus 10 receives the dispatch request information and accumulates the dispatch request information in the memory. The processes of steps A104 through A106 are repeatedly carried out at any point in time.

### (Step A107)

In step A107, the first determination section 12 of the data distribution apparatus 10 determines whether or not there is a combination that satisfies the first condition among the plurality of pieces of available guard information and the plurality of pieces of dispatch request information that have been accumulated in the memory. Here, the first condition is a condition in which a plurality of conditions below are all satisfied.
The classifications of provision data (guard information) match.
The location (wide-area location) included in available guard information encompasses a location included in dispatch request information.
The date and time (range of date and time) included in available guard information encompasses the date and time included in dispatch request information.
The current number of available guards included in available guard information is not less than the necessary number of persons included in dispatch request information.

### (No in Step A107)

In a case where it has been determined to be No in step A107, the information processing method S1A is terminated.

### (Yes in Step A107: Step A108)

In a case where it has been determined to be Yes in step A107, the second distribution path notification section 13 acquires, in step A108, connection information of the second distribution path.

### (Step A109)

In step A109, the second distribution path notification section 13 notifies the management server 20A of the connection information of the second distribution path. Moreover, the second distribution path notification section 13 requests the management server 20A to provide detailed available guard information corresponding to available guard information that satisfies the first condition.

### (Step A110)

In step A110, the second provision information transmission section 25 of the management server 20A connects to the second distribution path using the received connection information.

### (Step A111)

In step A109, the second distribution path notification section 13 of the data distribution apparatus 10 notifies the request server 30A of the connection information of the second distribution path. Moreover, the second distribution path notification section 13 requests the request server 30A to provide detailed dispatch request information corresponding to dispatch request information that satisfies the first condition.

### (Step A112)

In step A112, the second request information transmission section 35 of the request server 30A connects to the second distribution path using the received connection information.

### (Step A201)

In step A201, the second provision information generation section 24 of the management server 20A identifies a plurality of pieces of guard information that have been referred to when available guard information that satisfies the first condition was generated. The second provision information generation section 24 generates each piece of detailed available guard information based on one or more of or all of the identified pieces of guard information. The detailed available guard information that is generated is as described above with reference to FIG. 11. For example, the second provision information generation section 24 includes, in the detailed available guard information, the attributes “ability” and “rank” which are included in the guard information and are associated with the disclosure range 2.

### (Step A202)

In step A202, the second provision information transmission section 25 transmits one or more pieces of detailed available guard information to the data distribution apparatus 10 via the second distribution path. The second reception section 14 of the data distribution apparatus 10 receives the one or more pieces of detailed available guard information and accumulates the one or more pieces of detailed available guard information in the memory. The processes of steps A201 and A202 are repeatedly carried out at any point in time.

### (Step A203)

In step A203, the second request information generation section 34 of the request server 30A identifies picture data which has been referred to when dispatch request information that satisfies the first condition was generated. The second request information generation section 34 generates detailed dispatch request information based on the identified picture data. The detailed dispatch request information that is generated is as described above with reference to FIG. 12. For example, the second request information generation section 34 includes, in the detailed dispatch request information, a degree of crowdedness obtained by analyzing the picture data with use of AI.

### (Step A204)

In step A204, the second request information transmission section 35 transmits the detailed dispatch request information to the data distribution apparatus 10 via the second distribution path. The second reception section 14 of the data distribution apparatus 10 receives the detailed dispatch request information and accumulates the detailed dispatch request information in the memory. The processes of steps A203 and A204 are repeatedly carried out at any point in time.

### (Step A205)

In step A205, the second determination section 15 of the data distribution apparatus 10 determines whether or not there is a combination that satisfies the second condition among the plurality of pieces of detailed available guard information and the plurality of pieces of detailed dispatch request information that have been accumulated in the memory. Here, the second condition is a condition in which a plurality of conditions below are all satisfied.
The abilities match.
A value of the rank included in detailed available guard information includes a value of the rank included in detailed dispatch request information.
   (No in step A205)

In a case where it has been determined to be No in step A205, the information processing method S1A is terminated.

### (Yes in Step A205: Step A206)

In a case where it has been determined to be Yes in step A205, the provision notification section 16 provides, in step A206, the management server 20A with notification for prompting the management server 20A to provide guard information corresponding to detailed available guard information that satisfies the second condition to the request server 30A via the second distribution path.

### (Step A207)

In step A207, the provision data transmission section 26 of the management server 20A identifies guard information corresponding to the detailed available guard information that satisfies the second condition. The provision data transmission section 26 transmits the identified guard information to the request server 30A via the second distribution path.

### (Step A208)

In step A208, the provision data reception section 36 of the request server 30A receives guard information via the second distribution path.

### Effect of the Present Example Embodiment

The present example embodiment can more reliably provide guard information that is demanded by a request side, while enhancing security in a system for dispatching guards. The reason is that guard information is provided in a case where schematic available guard information and dispatch request information which are transmitted and received via the first distribution path satisfy a first condition, and in addition, detailed available guard information and detailed dispatch request information which are transmitted and received via the private second distribution path satisfy a second condition. This increases reliability that provided guard information conforms more to a detailed dispatch request from a request side, as compared with a case where guard information is provided when only a first condition is satisfied. In other words, a possibility that provided guard information does not conform to the detailed dispatch request from the request side decreases. As a result, the present example embodiment can reduce a possibility of leakage of guard information of a guard who does not actually receive a request, and security is enhanced.

### Fourth Example Embodiment

The following description will discuss a fourth example embodiment of the present invention in detail with reference to the drawings. The fourth example embodiment is an example aspect which is obtained by altering the data distribution system 1 according to the first example embodiment so as to be applied to an Internet of Things (IoT) sensor value collection system. In the present example embodiment, provision data, input data, first provision information, second provision information, first request information, and second request information which have the data structures according to the second example embodiment are used. The same reference numerals are given to constituent elements which have functions identical with those described in the first and second example embodiments, and descriptions as to such constituent elements are not repeated.

### Configuration of Data Distribution System

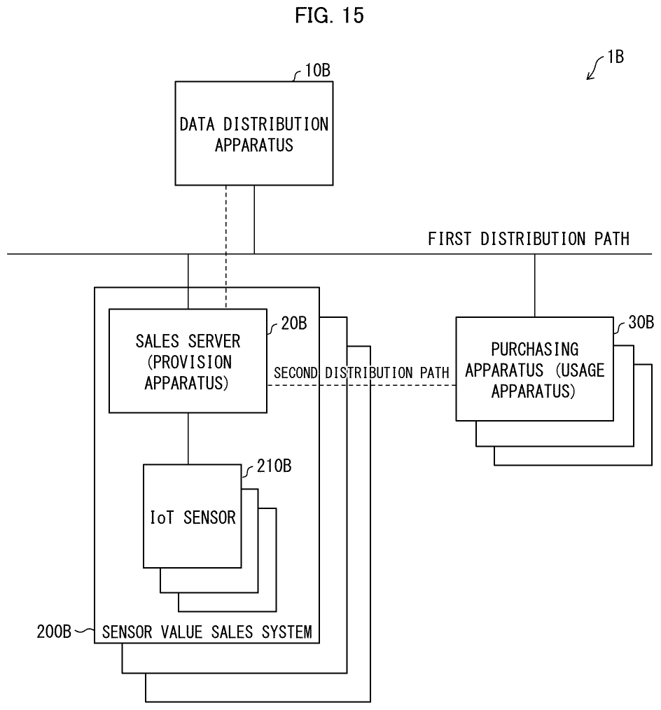

The following description will discuss a configuration of a data distribution system 1B according to the present example embodiment, with reference to FIG. 15. FIG. 15 is a block diagram illustrating the configuration of the data distribution system 1B. As illustrated in FIG. 15, the data distribution system 1B includes a data distribution apparatus 10B, one or more sensor value sales systems 200B, and one or more purchasing apparatuses 30B. The sensor value sales system 200B includes a sales server 20B and one or more IoT sensors 210B.

The data distribution system 1B is a communication system of publish/subscribe type model. Sensor value information is provided from the sensor value sales system 200B to the purchasing apparatus 30B under control of the data distribution apparatus 10B.

The data distribution apparatus 10B, the sales server 20B, and the purchasing apparatus 30B are communicably connected to each other via a first distribution path while the data distribution system 1B is operating. The data distribution apparatus 10B, the sales server 20B, and the purchasing apparatus 30B can be communicably connected to each other temporarily via a second distribution path. In FIG. 15, three sensor value sales systems 200B and three IoT sensors 210B are illustrated. However, the number of sensor value sales systems 200B that are included in the data distribution system 1B and the number of IoT sensors 210B that are included in each of the sensor value sales systems 200B are not limited to three. FIG. 15 illustrates three purchasing apparatuses 30B. However, the number of purchasing apparatuses 30B that are included in the data distribution system 1B is not limited to three.

### (Configuration of Data Distribution Apparatus)

The data distribution apparatus 10B is configured in a manner substantially similar to the provision apparatus 20 according to the first example embodiment, but is different in that provision data is notified in a case where a second condition is satisfied and further in a case where confirmation information is received.

Specifically, in a case where it has been determined to be Yes in step S107 of the data distribution method S10 described above with reference to FIG. 5, the data distribution apparatus 10B carries out a process of transmitting second provision information and a process of receiving confirmation information before carrying out step S108. That is, in a case where the second condition is satisfied (Yes in step S107), the provision notification section 16 transmits the second provision information to the purchasing apparatus 30B. Upon receipt of confirmation information from the purchasing apparatus 30B, the provision notification section 16 provides the sales server 20B with notification for prompting the sales server 20B to provide sensor value information to the purchasing apparatus 30B (in step S108). Here, the confirmation information includes information indicating approval of a user for purchase of corresponding sensor value information and information that is necessary for a payment.

### (Configuration of Sales Server)

The sales server 20B is an example configuration for realizing the “provision apparatus” recited in claims. The sales server 20B is configured in a manner substantially similar to the provision apparatus 20 according to the first example embodiment, but is different at least in that the sales server 20B is communicably connected to the IoT sensor 210B and that the sales server 20B sells sensor value information as provision data. There is also a difference in that a payment is carried out when the sensor value information is sold.

The sales server 20B and each of the IoT sensors 210B are connected to each other by a network. For example, the network is constituted by, but not limited to, a wireless LAN, a wired LAN, a WAN, mobile data communication, or a combination of at least two of these.

The sales server 20B generates sensor value information based on a sensor value acquired from the IoT sensor 210B. The sales server 20B may receive a sensor value by periodically making requests to the IoT sensor 210B, or may receive a sensor value that is periodically transmitted from the IoT sensor 210B.

The sales server 20B generates, based on the sensor value information, sales information as first provision information, and detailed sales information as second provision information.

In a case where notification for prompting provision of provision data to the purchasing apparatus 30B is provided from the data distribution apparatus 10B, the sales server 20B connects to a payment server (not illustrated) and completes a payment by the purchasing apparatus 30B.

### (Configuration of IoT Sensor)

The IoT sensor 210B is constituted by a sensor that is usable as IoT. Examples of the IoT sensor 210B include, but not limited to, a temperature sensor, a humidity sensor, a light sensor, a pressure sensor, a sound sensor, and the like. The IoT sensor 210B transmits a measured sensor value to the sales server 20B. The IoT sensor 210B may transmit a sensor value that has been periodically measured to the sales server 20B, or may transmit a sensor value that has been measured in response to periodic requests from the sales server 20B.

### (Configuration of Purchasing Apparatus)

The purchasing apparatus 30B is an example configuration for realizing the “usage apparatus” recited in claims. The purchasing apparatus 30B is configured in a manner substantially similar to the usage apparatus 30 according to the first example embodiment, but is different at least in that the purchasing apparatus 30B acquires user input information as input data and that the purchasing apparatus 30B can transmit confirmation information in response to reception of detailed sales information.

Specifically, the purchasing apparatus 30B may acquire user input information that is input by an operation on an input apparatus (not illustrated), or may acquire user input information from a user terminal (not illustrated) that is connected to the purchasing apparatus 30B via a network. The purchasing apparatus 30B generates, from the user input information, purchase information as first request information and detailed purchase information as second request information.

Moreover, after carrying out step S306 of the data usage method described above with reference to FIG. 7, the purchasing apparatus 30B carries out a process of receiving second provision information and a process of transmitting confirmation information before carrying out step S307. That is, in a case where the provision data reception section 36 has transmitted second request information and then received second provision information from the data distribution apparatus 10B via the second distribution path, the provision data reception section 36 displays the second provision information on a display apparatus (not illustrated). Upon receipt of confirmation information that has been input by the user in response to the display of the second provision information, the provision data reception section 36 transmits the confirmation information to the data distribution apparatus 10B via the second distribution path. After that, the provision data reception section 36 carries out step S307 and receives sensor value information via the second distribution path.

### (Provision Data: Sensor Value Information)

The sensor value information is an example of the “provision data” recited in claims, and is data that can be provided by the sales server 20B. The sensor value information includes actual data of a sensor value measured by the IoT sensor 210B.

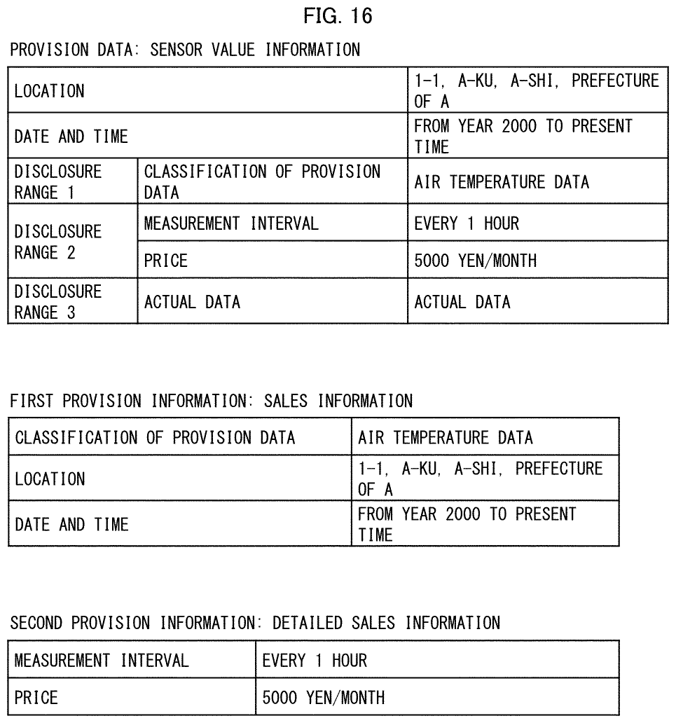

The following description will discuss a data structure of sensor value information with reference to FIG. 16. FIG. 16 is a diagram illustrating an example of data structures of sensor value information, sales information, and detailed sales information. As illustrated in FIG. 16, the sensor value information includes attributes “location” and “date and time”. The “location” is an attribute indicating an installation location of the IoT sensor 201B that measured a sensor value included in the sensor value information.

The sensor value information includes an attribute “classification of provision data” that is associated with a disclosure range 1. In this example, the “classification of provision data” is “air temperature data”.

The sensor value information includes attributes “measurement interval” and “price” which are associated with a disclosure range 2. In this example, the “measurement interval” is “every 1 hour”. The “price” is “5000 yen/month”.

The sensor value information includes an attribute “actual data” that is associated with a disclosure range 3.

### (First Provision Information: Sales Information)

The sales information is an example of the “first provision information” recited in claims. The sales information is generated based on the sensor value information. The following description will discuss sales information with reference to FIG. 16. As illustrated in FIG. 16, the sales information includes an attribute “classification of provision data”. The sales information also includes an attribute “location”. The sales information also includes an attribute “date and time”. As these attributes, the attributes included in the sensor value information are directly applied. These attributes are associated with the disclosure range 1.

### (Second Provision Information: Detailed Sales Information)

The detailed sales information is an example of the “second provision information” recited in claims. The detailed sales information is generated from the sensor value information. The following description will discuss detailed sales information with reference to FIG. 16. As illustrated in FIG. 16, the detailed sales information includes attributes “measurement interval” and “price”. As these attributes, the attributes included in the sensor value information are directly applied. These attributes are associated with the disclosure range 2.

### (User Input Information)

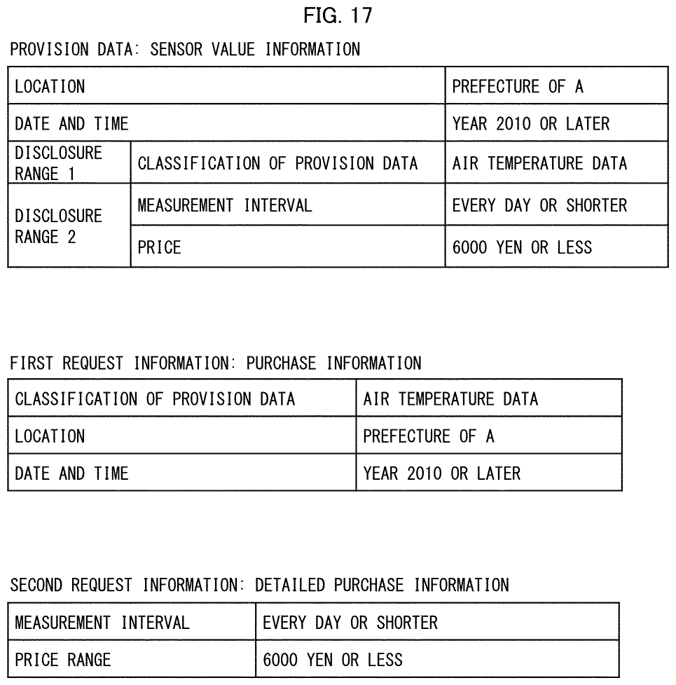

The user input information is an example of the “input data” recited in claims, and is information indicating a request by the purchasing apparatus 30B. The following description will discuss the user input information with reference to FIG. 17. FIG. 17 is a diagram illustrating an example of data structures of user input information, purchase information, and detailed purchase information. As illustrated in FIG. 17, the user input information includes attributes “location”, “date and time”, “classification of provision data”, “measurement interval”, and “price”. For example, the user input information is generated by inputting intended information by the user for each of these attributes.

### (First Request Information: Purchase Information)

The purchase information is an example of the “first request information” recited in claims. The purchase information is generated from user input information that is input data. The following description will discuss the purchase information with reference to FIG. 17. As illustrated in FIG. 17, the purchase information includes attributes “location”, “date and time”, and “classification of provision data”. Each of the attributes is an attribute that is associated with a disclosure range 1 and that is possessed by sensor value information that a purchaser wants to purchase.

Specifically, this purchase information indicates a request for purchasing sensor value information for which the “classification of provision data” is “air temperature data”. This attribute is generated from the attribute “classification of provision data” included in the user input information. Moreover, this purchase information indicates a request for purchasing sensor value information for which the “location” is “Prefecture of A”. This attribute is generated from the attribute “location” included in the user input information. Moreover, this purchase information indicates a request for purchasing sensor value information for which the “date and time” is “year 2010 or later”. This attribute is generated from the attribute “date and time” included in the user input information.

### (Second Request Information: Detailed Purchase Information)

The detailed purchase information is an example of the “second request information” recited in claims. The detailed purchase information is generated from user input information which is input data. The following description will discuss detailed purchase information generated from user input information, with reference to FIG. 17. As illustrated in FIG. 17, the detailed purchase information includes attributes “measurement interval” and “price”. Each of the attributes is an attribute that is associated with a disclosure range 2 and that is possessed by sensor value information that a purchaser wants to purchase.

Specifically, the detailed purchase information indicates a request for purchasing sensor value information for which the “measurement interval” is “every day or shorter”. This attribute is generated from the attribute “measurement interval” included in the user input information. This detailed purchase information indicates a request for purchasing sensor value information for which the “price” is “6000 yen or less”. This attribute is generated from the attribute “price” included in the user input information.

### <Flow of Information Processing Method>

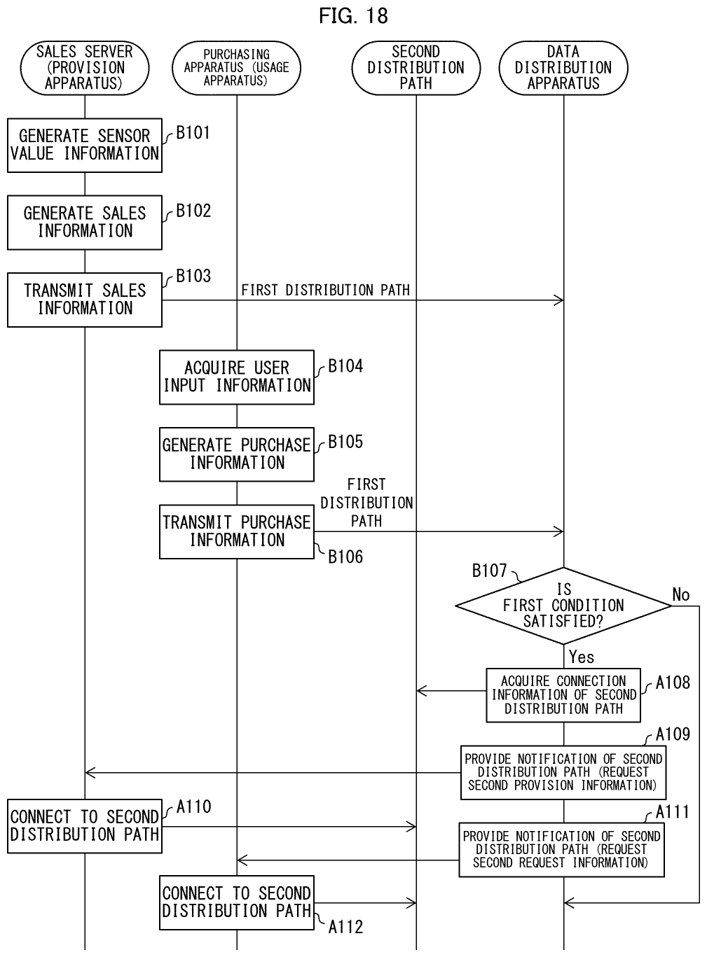

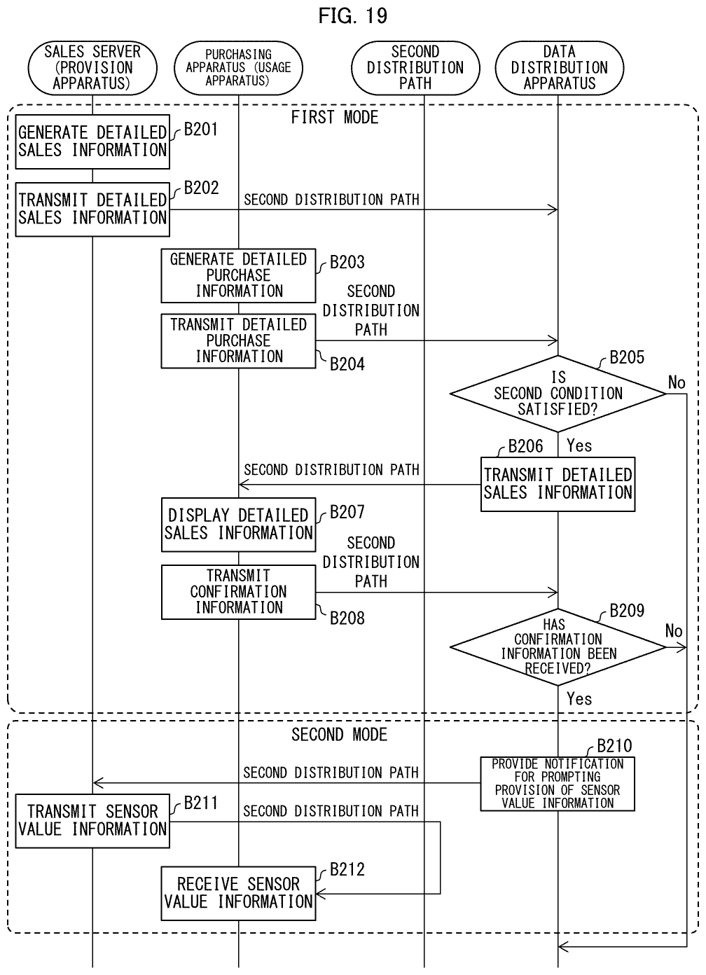

Next, the following description will discuss a flow of an information processing method S1B that is carried out by the data distribution system 1B, with reference to FIGS. 18 and 19. FIG. 18 is a sequence diagram illustrating the flow of the information processing method S1B. FIG. 19 is a sequence diagram continued from FIG. 18. The information processing method S1B is carried out when the data distribution apparatus 10B, the sales server 20B, and the purchasing apparatus 30B carry out the data distribution method S10, the data provision method S20, and the data usage method S30, respectively.

As illustrated in FIGS. 18 and 19, the information processing method S1B includes steps B101 through B107 and A108 through A112, and further includes steps B201 through B212 which are carried out after establishment of a second distribution path. After the second distribution path is established, there are a first mode (steps B201 through B205) in which a disclosure range of provision data is limited, and a second mode (steps B206 through B208) in which a disclosure range of provision data is not limited.

### (Step B101)

In step B101, the provision data acquisition section 21 of the sales server 20B acquires a sensor value from the IoT sensor 210B and generates sensor value information that includes the acquired sensor value. The sensor value information that is generated is as described above with reference to FIG. 16. Note that the provision data acquisition section 21 does not need to generate sensor value information every time the provision data acquisition section 21 acquires a sensor value from the IoT sensor 210B. For example, the provision data acquisition section 21 may accumulate acquired sensor values in a memory (not illustrated) and generate sensor value information that includes sensor values accumulated during a predetermined period.

### (Step B102)

In step B102, the first provision information generation section 22 generates sales information based on the sensor value information. The sales information that is generated is as described above with reference to FIG. 16. For example, the first provision information generation section 22 includes, in the sales information, the attributes “location” and “date and time” included in the sensor value information and the attribute “classification of provision data” associated with the disclosure range 1.

### (Step B103)

In step B103, the first provision information transmission section 23 transmits sales information to the data distribution apparatus 10B via the first distribution path. The first reception section 11 of the data distribution apparatus 10B receives the sales information and accumulates the sales information in the memory. The processes of steps B101 through B103 are repeatedly carried out at any point in time.

### (Step B104)

In step B104, the input data acquisition section 31 of the purchasing apparatus 30B acquires user input information. The user input information that is acquired is as described above with reference to FIG. 17.

### (Step B105)

In step B105, the first request information generation section 32 generates purchase information based on the user input information. The purchase information that is generated is as described above with reference to FIG. 17. For example, the first request information generation section 32 includes, in the purchase information, the attributes “location” and “date and time” included in the user input information and the attribute “classification of provision data” associated with the disclosure range 1.

### (Step B106)

In step B106, the first request information transmission section 33 transmits the purchase information to the data distribution apparatus 10B via the first distribution path. The first reception section 11 of the data distribution apparatus 10B receives the purchase information and accumulates the purchase information in the memory. The processes of steps B104 through A106 are repeatedly carried out at any point in time.

### (Step B107)

In step B107, the first determination section 12 of the data distribution apparatus 10B determines whether or not there is a combination that satisfies a first condition among the plurality of pieces of sales information and the plurality of pieces of purchase information that have been accumulated in the memory. Here, the first condition is a condition in which a plurality of conditions below are all satisfied.
Classifications of provision data (air temperature data, etc.) match.
A location included in sales information falls within a range of location included in purchase information.
A date and time included in sales information falls within a range of date and time included in purchase information.

### (No in Step B107)

In a case where it has been determined to be No in step B107, the information processing method S1B is terminated.

### (Yes in Step B107: Steps A108 Through A112)

In a case where it has been determined to be Yes in step B107, the data distribution system 1B carries out steps A108 through A112 in a manner similar to that in the information processing method S1A. Thus, the sales server 20B and the purchasing apparatus 30B connect to a second distribution path.

### (Step B201)

In step B201, the second provision information generation section 24 of the sales server 20B generates detailed sales information corresponding to sales information that satisfies the first condition. The detailed sales information that is generated is as described above with reference to FIG. 16. For example, the second provision information generation section 24 includes, in the detailed sales information, the attributes “measurement interval” and “price” which are associated with the disclosure range 2 and are included in the sensor value information.

### (Step B202)

In step B202, the second provision information transmission section 25 transmits the detailed sales information to the data distribution apparatus 10B via the second distribution path. The second reception section 14 of the data distribution apparatus 10B receives one or more pieces of detailed sales information and accumulates the one or more pieces of detailed sales information in the memory. The processes of steps B201 and B202 are repeatedly carried out at any point in time.

### (Step B203)

In step B203, the second request information generation section 34 of the purchasing apparatus 30B generates detailed purchase information corresponding to purchase information that satisfies the first condition. The detailed purchase information that is generated is as described above with reference to FIG. 17. For example, the second request information generation section 34 includes, in the detailed purchase information, the attributes “measurement interval” and “price” which are included in the user input information and are associated with the disclosure range 2.

### (Step B204)

In step B204, the second request information transmission section 35 transmits the detailed purchase information to the data distribution apparatus 10B via the second distribution path. The second reception section 14 of the data distribution apparatus 10B receives detailed purchase information and accumulates the detailed purchase information in the memory. The processes of steps B203 and B204 are repeatedly carried out at any point in time.

### (Step B205)

In step B205, the second determination section 15 of the data distribution apparatus 10B determines whether or not there is a combination that satisfies a second condition among the plurality of pieces of detailed sales information and the plurality of pieces of detailed purchase information that have been accumulated in the memory. Here, the second condition is a condition in which a plurality of conditions below are all satisfied.
A measurement interval included in detailed sales information falls within a range of measurement interval included in detailed purchase information.
A price included in detailed sales information falls within a price included in detailed purchase information.

### (No in Step B205)

In a case where it has been determined to be No in step B205, the information processing method S1B is terminated.

### (Yes in Step B205: Step B206)

In a case where it has been determined to be Yes in step B205, the provision notification section 16 transmits, in step B206, detailed sales information to the purchasing apparatus 30B via the second distribution path.

### (Step B207)

In step B207, the provision data reception section 36 of the purchasing apparatus 30B displays the received detailed sales information on the display apparatus. Here, the user confirms content of the displayed detailed sales information, and inputs confirmation information in a case where the user approves the sales. The confirmation information includes information indicating the approval and information necessary for a payment.

### (Step B208)

In step B208, the provision data reception section 36 transmits the confirmation information which has been input by the user in step B207 to the data distribution apparatus 10B via the second distribution path. In step B208, in a case where no confirmation information has been input, the information processing method S1B is terminated.

### (Step B209)

In step B209, the provision notification section 16 of the data distribution apparatus 10B determines whether or not confirmation information has been received.

### (No in Step B209)

In a case where it has been determined to be No in step B209, the information processing method S1B is terminated.

### (Yes in Step B209: Step B210)

In a case where it has been determined to be Yes in step B209, the provision notification section 16 provides, in step B210, the sales server 20B with notification for prompting the sales server 20B to provide sensor value information corresponding to detailed sales information that satisfies the second condition to the request server 30A via the second distribution path. At this time, the provision notification section 16 provides notification together with the information necessary for a payment, which is included in the confirmation information.

### (Step B211)

In step B211, the provision data transmission section 26 of the sales server 20B connects to the payment server using the information necessary for a payment, and completes a payment by the purchasing apparatus 30B. In a case where the payment has been successfully carried out, the provision data transmission section 26 identifies sensor value information corresponding to the detailed sales information that satisfies the second condition. Moreover, the provision data transmission section 26 transmits the identified sensor value information to the purchasing apparatus 30B via the second distribution path.

### (Step B212)

In step B212, the provision data reception section 36 of the purchasing apparatus 30B receives the sensor value information via the second distribution path.

In the present example embodiment, the second distribution path notification section 13 may transmit sales information to the purchasing apparatus 30B in a case where the first condition is satisfied, and the second distribution path notification section 13 may establish a second distribution path in a case where the second distribution path notification section 13 has received confirmation information from the purchasing apparatus 30B. As such, sales information is presented when the first condition is satisfied, and confirmation information is requested to the purchasing apparatus 30B. Thus, it is possible to bring about an effect that a second distribution path does not need to be established in a case where the purchase is not demanded.

### Effect of the Present Example Embodiment

The present example embodiment can more reliably sell sensor value information demanded by a purchaser, while enhancing security. The reason is that sensor value information is sold in a case where schematic sales information and purchase information which are transmitted and received via the first distribution path satisfy a first condition, and in addition, detailed sales information and detailed purchase information which are transmitted and received via the private second distribution path satisfy a second condition. This increases reliability that sold sensor value information is sensor value information that is demanded by a purchaser, as compared with a case where sensor value information is sold when only a first condition is satisfied. In other words, a possibility that sold data is data which is not demanded by a purchaser decreases. As a result, the present example embodiment can reduce a possibility of information leakage due to sales of data which is not demanded by a purchaser, and security is enhanced.

### Fifth Example Embodiment

The following description will discuss a fifth example embodiment of the present invention in detail with reference to the drawings. The fifth example embodiment is an example aspect which is obtained by altering the data distribution system 1 according to the first example embodiment so as to be applied to a lost child search system. In the present example embodiment, provision data, input data, first provision information, second provision information, first request information, and second request information which have the data structures according to the second example embodiment are used. The same reference numerals are given to constituent elements which have functions identical with those described in the first and second example embodiments, and descriptions as to such constituent elements are not repeated.

### Configuration of Data Distribution System

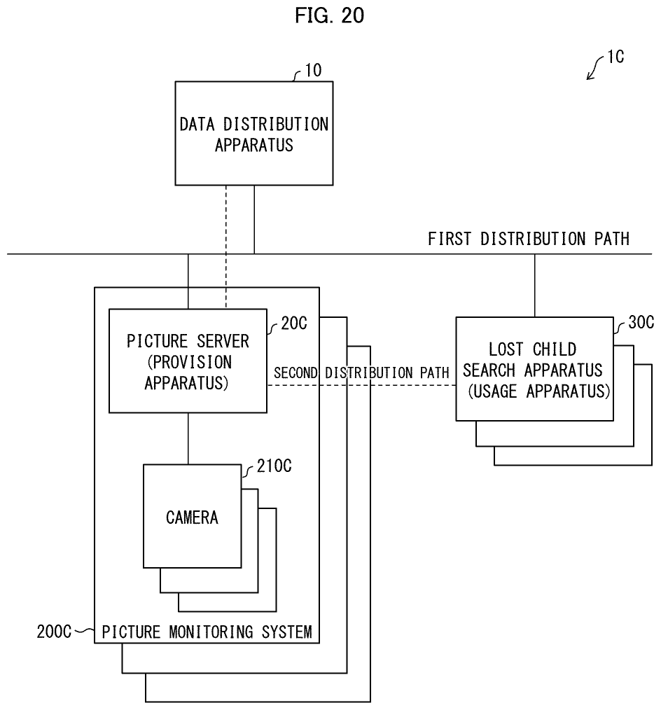

The following description will discuss a configuration of a data distribution system 1C according to the present example embodiment, with reference to FIG. 20. FIG. 20 is a block diagram illustrating the configuration of the data distribution system 1C. As illustrated in FIG. 20, the data distribution system 1C includes a data distribution apparatus 10, one or more picture monitoring systems 200C, and one or more lost child search apparatuses 30C. The picture monitoring system 200C includes a picture server 20C and one or more cameras 210C. Each of the picture monitoring systems 200C monitors by pictures the inside of a facility such as, for example, a theme park, a stadium, an office building, a commercial building, a shopping district, a transportation facility, or the like. Moreover, the cameras 210C are installed at various places in the facility. The lost child search apparatus 30C is installed at a lost child center in a facility of interest.

The data distribution system 1C is a communication system of publish/subscribe type model. The data distribution system 1C provides, under control of the data distribution apparatus 10, picture data obtained by the camera 210C from the picture monitoring system 200C to the lost child search apparatus 30C.

The data distribution apparatus 10, the picture server 20C, and the lost child search apparatus 30C. are communicably connected to each other via a first distribution path while the data distribution system 1C is operating. The data distribution apparatus 10, the picture server 20C, and the lost child search apparatus 30C can be communicably connected to each other temporarily via a second distribution path. In FIG. 20, three picture monitoring systems 200C and three cameras 210C are illustrated. However, the number of picture monitoring systems 200C that are included in the data distribution system 1C and the number of cameras 210C that are included in each of the picture monitoring systems 200C are not limited to three. Moreover, FIG. 20 illustrates three lost child search apparatuses 30C. However, the number of lost child search apparatuses 30C that are included in the data distribution system 1C is not limited to three.

### (Configuration of Picture Server)

The picture server 20C is an example configuration for realizing the “provision apparatus” recited in claims. The picture server 20C is configured in a manner substantially similar to the provision apparatus 20 according to the first example embodiment, but is different at least in that the picture server 20C is communicably connected to the camera 210C and that the picture server 20C acquires picture data as provision data.

The picture server 20C and each of the cameras 210C are connected to each other by a network. For example, the network is constituted by, but not limited to, a wireless LAN, a wired LAN, a WAN, mobile data communication, or a combination of at least two of these.

The picture server 20C may receive picture data by periodically making requests to the camera 210C, or may receive picture data periodically transmitted from the camera 210C.

The picture server 20C generates, from the picture data, subject information as first provision information, and detailed subject information as second provision information.

### (Configuration of Camera)

The camera 210C is installed at a place where a space within a facility can be imaged. The camera 210C includes, for example, a light collecting lens, an imaging element, a processor, a memory, and a communication interface. The camera 210C converts light emitted from the light collecting lens into an electric signal by the imaging element. Then, the camera 210C carries out A/D conversion of the electric signal for image processing to generate picture data. The picture data is accompanied by information indicating a date and time of shooting and a place of shooting. The camera 210C transmits the generated picture data to the picture server 20C via the communication interface. For example, in a case where the camera 210 generates a still image as the picture data, the camera 210 may periodically generate and transmit the picture data, or may transmit the picture data in response to periodic requests from the picture server 20C. Alternatively, for example, in a case where the camera 210 generates a moving image as picture data, the picture data that is generated is transmitted in real time.

### (Configuration of Lost Child Search Apparatus)

The lost child search apparatus 30C is an example configuration for realizing the “usage apparatus” recited in claims. The lost child search apparatus 30C is configured in a manner substantially similar to the usage apparatus 30 according to the first example embodiment, but is different at least in that the lost child search apparatus 30C acquires user input information as input data.

The lost child search apparatus 30C may, for example, acquire user input information that is input by an operator of a lost child center via an input apparatus (not illustrated), or acquire user input information from a user terminal (not illustrated) that is connected to the lost child search apparatus 30C via a network.

The lost child search apparatus 30C generates, from the user input information, lost child information as first request information, and detailed lost child information as second request information.

### (Provision Data: Picture Data)

The picture data is an example of the “provision data” recited in claims, and is data that can be provided by the picture server 20C. The picture data is data generated by the camera 210C.

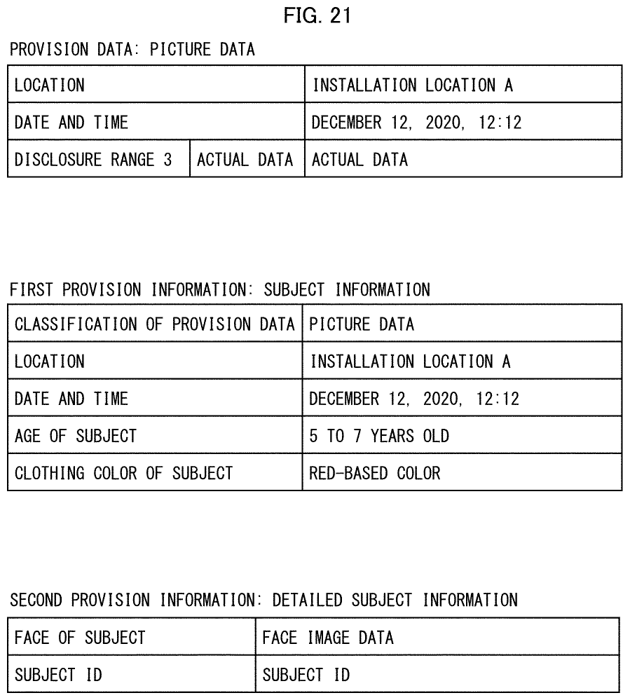

The following description will discuss a data structure of picture data with reference to FIG. 21. FIG. 21 is a diagram illustrating an example of data structures of picture data, subject information, and detailed subject information. As illustrated in FIG. 21, the picture data includes attributes “location”, “date and time”, and “actual data”. The “location” is an installation location of the camera 210C. The “date and time” is a date and time at which the picture data was obtained. The “actual data” is one or more pieces of frame data. In a case where the picture data is transmitted from the camera 210C in real time as a moving image, the “actual data” is one or more most recent pieces of frame data that have been extracted from the moving image at predetermined intervals. In this case, the “date and time” is a range of the date and time during which the one or more extracted pieces of frame data were generated. The “actual data” is associated with a disclosure range 3.

### (First Provision Information: Subject Information)

The subject information is an example of the “first provision information” recited in claims. The subject information is generated from the picture data. The following description will discuss subject information with reference to FIG. 21. As illustrated in FIG. 21, the subject information includes “picture data” as an attribute “classification of provision data”. In the present example embodiment, it is predetermined to include “picture data” as the “classification of provision data”. Moreover, the subject information includes “installation location A” as a “location”, and “Dec. 12, 2020, 12:12” as a “date and time”. These attributes are generated from information included in the picture data. Moreover, the subject information includes “5 to 7 years old” as an “age of subject”, and “red-based color” as a “clothing color of subject”. These attributes are generated by analyzing actual data of the picture data with use of AI. Note that it is predetermined that a disclosure range 1 is associated with these attributes “age of subject” and “clothing color of subject” that have been generated by analysis.

### (Second Provision Information: Detailed Subject Information)

The detailed subject information is an example of the “second provision information” recited in claims. The detailed subject information is generated from the picture data. The following description will discuss detailed subject information with reference to FIG. 21. As illustrated in FIG. 21, the detailed subject information includes “face image data” as an attribute “face of subject”, and “subject ID”. These attributes are generated by analyzing actual data of the picture data with use of AI. Note that it is predetermined that a disclosure range 2 is associated with these attributes.

### (User Input Information)

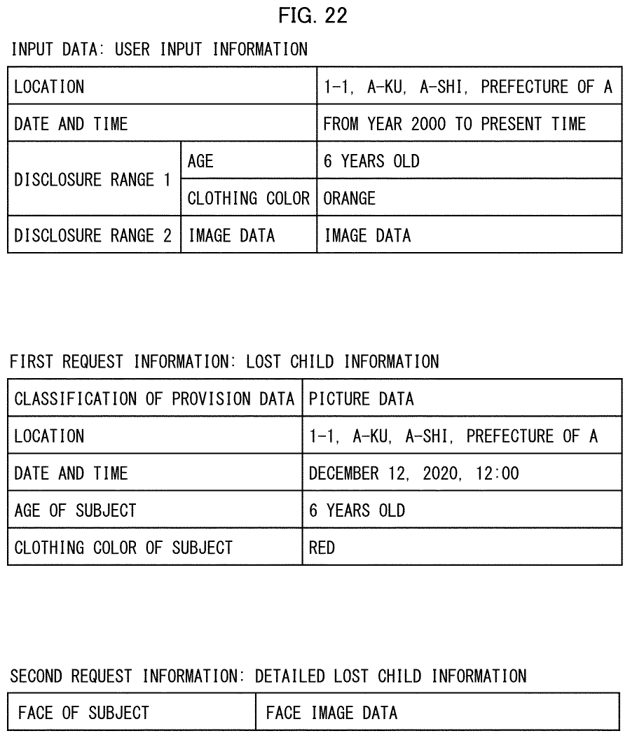

The user input information is an example of the “input data” recited in claims, and is information indicating a request by the lost child search apparatus 30C. The following description will discuss the user input information with reference to FIG. 22. FIG. 22 is a diagram illustrating an example of data structures of user input information, lost child information, and detailed lost child information. As illustrated in FIG. 22, the user input information includes attributes “location”, “date and time”, “age”, “clothing color”, and “image data”. For example, the user input information is generated when an operator of the lost child center has input, for each of these attributes, information which is heard from a requester of lost child search. The attribute “image data” is input by scanning a photograph provided by the requester.

### (First Request Information: Lost Child Information)

The lost child information is an example of the “first request information” recited in claims. The lost child information is generated from user input information. The following description will discuss the lost child information with reference to FIG. 22. As illustrated in FIG. 22, the lost child information includes attributes “classification of provision data”, “date and time”, “location”, “age” and “clothing color”. These attributes are attributes that are associated with a disclosure range 1 and that are possessed by picture data that a user wants to use.

Specifically, the lost child information indicates a request for using data for which the “classification of provision data” is “picture data”. In the present example embodiment, it is predetermined to include, in the lost child information, “picture data” as the attribute “classification of provision data”. This lost child information indicates a request for using picture data for which the attribute “date and time” is near to “Dec. 12, 2020, 12:00”. This lost child information indicates a request for using picture data for which the attribute “location” is near to “1-1, A-ku, A-shi, Prefecture of A”. Moreover, this lost child information indicates a request for using picture data for which the attribute “age of subject” is near to “6 years old”. Moreover, this lost child information indicates a request for using picture data for which the “clothing color of subject” is similar to “red”. Note that these attributes included in the lost child information are generated from the attributes that are associated with the disclosure range 1 and are included in the user input information.

### (Second Request Information: Detailed Lost Child Information)

The detailed lost child information is an example of the “second request information” recited in claims. The detailed lost child information is generated from user input information. The following description will discuss detailed lost child information with reference to FIG. 22. As illustrated in FIG. 22, the detailed lost child information includes an attribute “face of subject”. The detailed lost child information indicates a request for using picture data that includes a “face” similar to the “face of subject”. The attribute “face of subject” is generated by analyzing the attribute “image data” included in the user input information.

### <Flow of Information Processing Method>

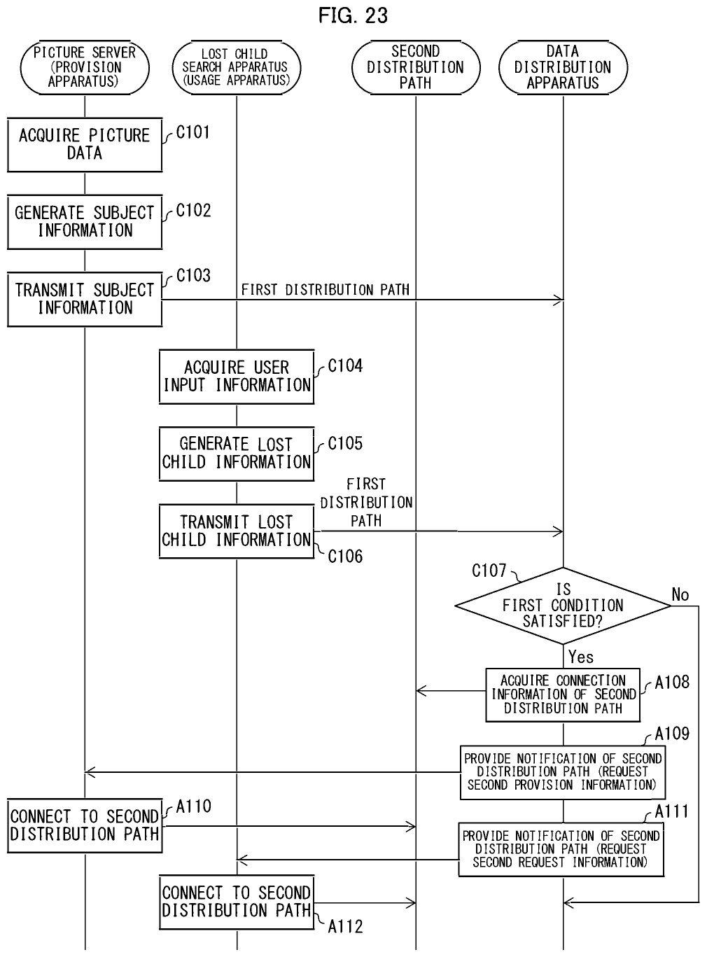

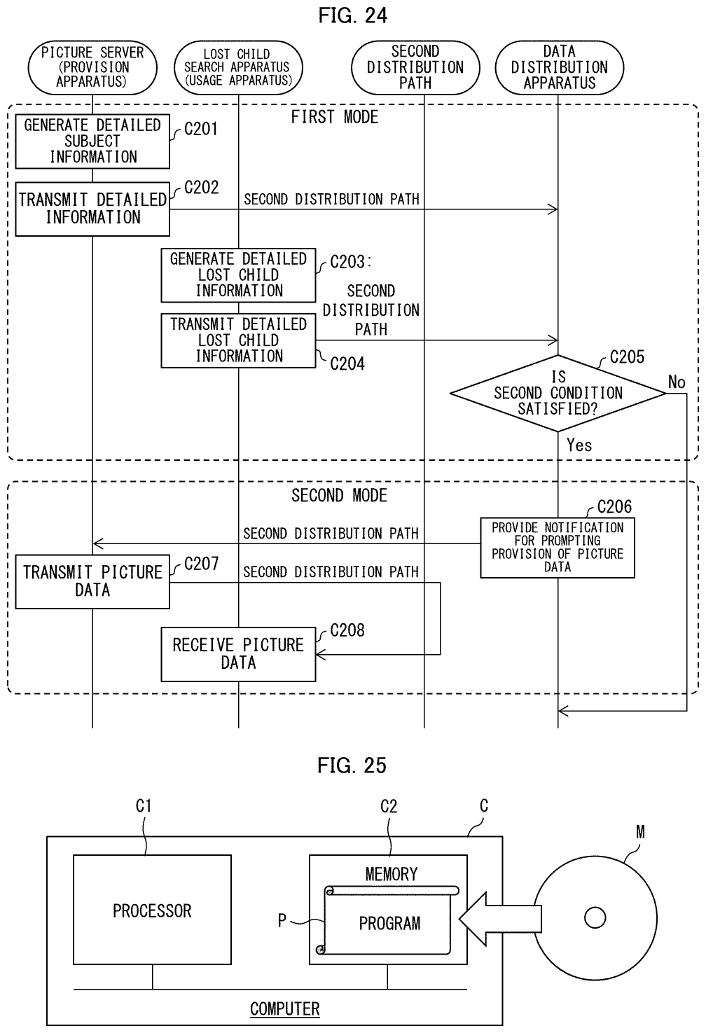

Next, the following description will discuss a flow of an information processing method S1C that is carried out by the data distribution system 1C, with reference to FIGS. 23 and 24. FIG. 23 is a sequence diagram illustrating the flow of the information processing method S1C. FIG. 24 is a sequence diagram continued from FIG. 23. The information processing method S1C is carried out when the data distribution apparatus 10, the picture server 20C, and the lost child search apparatus 30C carry out the data distribution method S10, the data provision method S20, and the data usage method S30, respectively.

As illustrated in FIGS. 23 and 24, the information processing method S1C includes steps C101 through C107 and steps A108 through A112, and includes steps C201 through C208 which are carried out after a second distribution path is established. After the second distribution path is established, there are a first mode (steps C201 through C205) in which a disclosure range of provision data is limited, and a second mode (steps C206 through C208) in which a disclosure range of provision data is not limited.

### (Step C101)

In step C101, the provision data acquisition section 21 of the picture server 20C acquires picture data from the camera 210C. The picture data that is acquired is as described above with reference to FIG. 21. For example, in a case where a still image is transmitted from the camera 210C, the provision data acquisition section 21 sets the received still image to be picture data. In a case where a moving image is transmitted from the camera 210C in real time, the provision data acquisition section 21 extracts one or more most recent pieces of frame data at predetermined intervals from the received moving image, and sets the one or more extracted frames to be picture data.

### (Step C102)

In step C102, the first provision information generation section 22 generates subject information based on the picture data. The subject information that is generated is as described above with reference to FIG. 21. For example, the first provision information generation section 22 generates attributes “age of subject” and “clothing color of subject” by analyzing the picture data with use of AI, and includes these attributes in the subject information.

### (Step C103)

In step C103, the first provision information transmission section 23 transmits the subject information to the data distribution apparatus 10 via the first distribution path. The first reception section 11 of the data distribution apparatus 10 receives the subject information and accumulates the subject information in the memory. The processes of steps C101 through C103 are repeatedly carried out at any point in time.

### (Step C104)

In step C104, the input data acquisition section 31 of the lost child search apparatus 30C acquires user input information. As described above, for example, user input information is input by the operator of the lost child center. The user input information that is input is as described above with reference to FIG. 22.

### (Step C105)

In step C105, the first request information generation section 32 generates lost child information based on the user input information. The lost child information that is generated is as described above with reference to FIG. 22. For example, the first request information generation section 32 includes, in the lost child information, the attributes “location” and “date and time” included in the user input information, and the attributes “age” and “clothing color” associated with the disclosure range 1.

### (Step C106)

In step C106, the first request information transmission section 33 transmits lost child information to the data distribution apparatus 10 via the first distribution path. The first reception section 11 of the data distribution apparatus 10 receives the lost child information and accumulates the lost child information in the memory. The processes of steps C104 through C106 are repeatedly carried out at any point in time.

### (Step C107)

In step C107, the first determination section 12 of the data distribution apparatus 10 determines whether or not there is a combination that satisfies a first condition among the plurality of pieces of subject information and the plurality of pieces of lost child information that have been accumulated in the memory. Here, the first condition is a condition in which a plurality of conditions below are all satisfied.
Classification of provision data (picture data) match.
A distance between a location included in subject information and a location included in lost child information is equal to or less than a threshold value.
A period between a date and time included in subject information and a date and time included in lost child information is equal to or less than a threshold value.
A range of age of a subject included in subject information encompasses an age of a subject included in lost child information.
A clothing color of a subject included in subject information is similar to a clothing color of a subject included in lost child information.

### (No in Step C107)

In a case where it has been determined to be No in step C107, the information processing method S1C is terminated.

### (Yes in Step C107: Steps A108 Through A112)

In a case where it has been determined to be Yes in step A107, the data distribution system 1C carries out steps A108 through A112 in a manner similar to that in the information processing method S1A. Thus, the picture server 20C and the lost child search apparatus 30C connect to a second distribution path.

### (Step C201)

In step C201, the second provision information generation section 24 of the picture server 20C identifies picture data which has been referred to when the subject information that satisfies the first condition was generated. The second provision information generation section 24 generates detailed subject information based on the identified picture data. The detailed subject information that is generated is as described above with reference to FIG. 21. For example, the second provision information generation section 24 generates “face image data” which has been extracted from the picture data and “subject ID” which has been identified by analyzing the “face image data” with use of AI, and includes these attributes in the detailed subject information.

### (Step C202)

In step C202, the second information transmission section 25 transmits the detailed subject information to the data distribution apparatus 10 via the second distribution path. The second reception section 14 of the data distribution apparatus 10 receives one or more pieces of detailed subject information and accumulates the one or more pieces of detailed subject information in the memory. The processes of steps C201 and C202 are repeatedly carried out at any point in time.

### (Step C203)

In step C203, the second request information generation section 34 of the lost child search apparatus 30C identifies picture data that has been referred to when the lost child information that satisfies the first condition was generated. The second request information generation section 34 generates detailed lost child information based on the identified picture data. The detailed lost child information that is generated is as described above with reference to FIG. 22. For example, the second request information generation section 34 extracts “face image data” from the “image data” included in the user input information, and includes the attribute in the detailed lost child information.

### (Step C204)

In step C204, the second request information transmission section 35 transmits the detailed lost child information to the data distribution apparatus 10 via the second distribution path. The second reception section 14 of the data distribution apparatus 10 receives the detailed lost child information and accumulates the detailed lost child information in the memory. The processes of steps C203 and C204 are repeatedly carried out at any point in time.

### (Step C205)

In step C205, the second determination section 15 of the data distribution apparatus 10 determines whether or not there is a combination that satisfies a second condition among the plurality of pieces of detailed subject information and the plurality of pieces of detailed lost child information that have been accumulated in the memory. Here, the second condition is a condition in which a plurality of conditions below are all satisfied.
A degree of similarity between face image data included in detailed subject information and face image data included in detailed lost child information is equal to or greater than a threshold value.

### (No in Step C205)

In a case where it has been determined to be No in step C205, the information processing method S1C is terminated.

### (Yes in Step C205: Step C206)

In a case where it has been determined to be Yes in step C205, the provision notification section 16 provides, in step C206, the picture server 20C with notification for prompting the picture server 20C to provide picture data corresponding to the detailed subject information that satisfies the second condition to the lost child search apparatus 30C via the second distribution path.

### (Step C207)

In step C207, the provision data transmission section 26 of the picture server 20C identifies picture data corresponding to the detailed subject information that satisfies the second condition. Moreover, the provision data transmission section 26 transmits the identified picture data to the lost child search apparatus 30C via the second distribution path.

### (Step A208)

In step A208, the provision data reception section 36 of the lost child search apparatus 30C receives the picture data via the second distribution path.

### Effect of the Present Example Embodiment

The present example embodiment can more reliably provide picture data that is demanded by a requester of lost child search, while enhancing security. The reason is that picture data is provided in a case where schematic subject information and lost child information which are transmitted and received via the first distribution path satisfy a first condition, and in addition, detailed subject information and detailed lost child information which are transmitted and received via the private second distribution path satisfy a second condition. This increases reliability that provided picture data includes, as a subject, a lost child who is searched, as compared with a case where picture data is provided when only a first condition is satisfied. In other words, a possibility that provided picture data does not include the lost child as a subject decreases. As a result, the present example embodiment can reduce a possibility of information leakage due to provision of picture data which does not include the lost child as a subject, and security is enhanced.

### [Software Implementation Example]

The functions of part of or all of the apparatuses constituting each of the data distribution systems 1, 1A, 1B, and 1C can be realized by hardware such as an integrated circuit (IC chip) or can be alternatively realized by software.

In the latter case, each of the apparatuses constituting each of the data distribution systems 1, 1A, 1B, and 1C is realized by, for example, a computer that executes instructions of a program that is software realizing the foregoing functions. FIG. 25 illustrates an example of such a computer (hereinafter, referred to as “computer C”). The computer C includes at least one processor C1 and at least one memory C2. The memory C2 stores a program P for causing the computer C to function as the apparatuses constituting each of the data distribution systems 1, 1A, 1B, and 1C. In the computer C, the processor C1 reads the program P from the memory C2 and executes the program P, so that the functions of the apparatuses constituting each of the data distribution systems 1, 1A, 1B, and 1C are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some of or all of the foregoing example embodiments can also be described as below. Note, however, that the present invention is not limited to the following supplementary notes.

### (Supplementary Note 1)

A data distribution apparatus, including: a first reception means of receiving first provision information and first request information via a first distribution path, the first provision information pertaining to provision data which is providable by a provision apparatus, and the first request information indicating a request which is related to provision data and made by a usage apparatus; a first determination means of determining whether or not the first provision information and the first request information satisfy a first condition; a second distribution path notification means of providing the provision apparatus and the usage apparatus with notification for prompting the provision apparatus and the usage apparatus to connect to a second distribution path in a case where the first condition is satisfied, the second distribution path being private and different from the first distribution path; a second reception means of receiving second provision information and second request information via the second distribution path, the second provision information pertaining to the provision data and being more specific than the first provision information, and the second request information indicating the request and being more specific than the first request information; a second determination means of determining whether or not the second provision information and the second request information satisfy a second condition; and a provision notification means of providing the provision apparatus with notification for prompting the provision apparatus to provide the provision data to the usage apparatus via the second distribution path in a case where the second condition is satisfied.

According to the configuration, it is possible to more reliably provide data demanded by a user, while enhancing security. The reason is that provision data is provided in a case where first provision information and first request information which are transmitted and received via the first distribution path satisfy a first condition, and in addition, detailed second provision information and second request information which are transmitted and received via the private second distribution path satisfy a second condition. This increases reliability that provided data is data demanded by a user, as compared with a case where provision data is provided when only a first condition is satisfied. In other words, a possibility that provided data is data which is not demanded by a user decreases. As a result, the present example embodiment can reduce a possibility of information leakage due to provision of data which is not demanded by a user, and security is enhanced.

### (Supplementary Note 2)

The data distribution apparatus according to supplementary note 1, in which: in a case where the second condition is satisfied, the provision notification means transmits the second provision information to the usage apparatus; and in a case where the provision notification means has received confirmation information from the usage apparatus, the provision notification means provides the provision apparatus with notification for prompting the provision apparatus to provide the provision data to the usage apparatus.

According to the configuration, in a case where confirmation information is not received from the usage apparatus, provision data is not provided. Therefore, reliability that the provided data is data that is demanded by the user is further increased.

### (Supplementary Note 3)

The data distribution apparatus according to supplementary note 1 or 2, in which: in a case where the first condition is satisfied, the second distribution path notification means transmits the first provision information to the usage apparatus; and in a case where the second distribution path notification means has received confirmation information from the usage apparatus, the second distribution path notification means provides the provision apparatus and the usage apparatus with notification for prompting the provision apparatus and the usage apparatus to connect to the second distribution path.

According to the configuration, in a case where confirmation information is not received from the usage apparatus, notification for prompting connection to the second distribution path is not provided. Therefore, it is not necessary to connect to the second distribution path when doing so is unnecessary.

### (Supplementary Note 4)

The data distribution apparatus according to any one of supplementary notes 1 through 3, in which: in a case where the second determination means has determined that i-th provision information and i-th request information satisfy an i-th condition, the second reception means receives, for i which is 2, . . . , and n-1 (n is an integer of 3 or more), (i+1)th provision information and (i+1)th request information via the second distribution path, the (i+1)th provision information pertaining to the provision data and being more specific than the i-th provision information, and the (i+1)th request information indicating the request and being more specific than the i-th request information; and in a case where n-th provision information and n-th request information satisfy an n-th condition, the provision notification means provides the provision apparatus with notification for prompting the provision apparatus to provide the provision data to the usage apparatus.

According to the configuration, provision data is provided to the usage apparatus after condition determination in a plurality of stages. Therefore, reliability that the provision data is data demanded by the user is further increased.

### (Supplementary Note 5)

A provision apparatus which is communicably connected to a data distribution apparatus described in any one of supplementary notes 1 through 4 via the first distribution path, the provision apparatus including: a provision data acquisition means of acquiring the provision data; a first provision information generation means of generating the first provision information based on the provision data; a first provision information transmission means of transmitting the first provision information to the data distribution apparatus via the first distribution path; a second provision information generation means of generating the second provision information based on the provision data upon receipt of notification for prompting connection to the second distribution path; a second provision information transmission means of transmitting the second provision information to the data distribution apparatus via the second distribution path; and a provision data transmission means of transmitting the provision data to the usage apparatus via the second distribution path upon receipt of notification for prompting provision of the provision data.

According to the configuration, an effect similar to that of supplementary note 1 is brought about.

### (Supplementary Note 6)

A usage apparatus which is communicably connected to a data distribution apparatus described in any one of supplementary notes 1 through 4 via the first distribution path, the usage apparatus including: an input data acquisition means of acquiring input data indicating the request; a first request information generation means of generating first request information based on the input data; a first request information transmission means of transmitting the first request information to the data distribution apparatus via the first distribution path; a second request information generation means of generating the second request information based on the input data upon receipt of notification for prompting connection to the second distribution path; a second request information transmission means of transmitting the second request information to the data distribution apparatus via the second distribution path; and a provision data reception means of receiving the provision data from the provision apparatus via the second distribution path.

According to the configuration, an effect similar to that of supplementary note 1 is brought about.

### (Supplementary Note 7)

A data distribution system, including: the data distribution apparatus described in any one of supplementary notes 1 through 4; the provision apparatus described in supplementary note 5; and the usage apparatus described in supplementary note 6.

According to the configuration, an effect similar to that of supplementary note 1 is brought about.

### (Supplementary Note 8)

A data distribution method, including: receiving first provision information and first request information via a first distribution path, the first provision information pertaining to provision data which is providable by a provision apparatus, and the first request information indicating a request which is related to provision data and made by a usage apparatus; determining whether or not the first provision information and the first request information satisfy a first condition; providing the provision apparatus and the usage apparatus with notification for prompting the provision apparatus and the usage apparatus to connect to a second distribution path in a case where the first condition is satisfied, the second distribution path being private and different from the first distribution path; receiving second provision information and second request information via the second distribution path, the second provision information pertaining to the provision data and being more specific than the first provision information, and the second request information indicating the request and being more specific than the first request information; determining whether or not the second provision information and the second request information satisfy a second condition; and providing the provision apparatus with notification for prompting the provision apparatus to provide the provision data to the usage apparatus via the second distribution path in a case where the second condition is satisfied.

According to the configuration, an effect similar to that of supplementary note 1 is brought about.

### (Supplementary Note 9)

A data provision method, including: being communicably connected to a data distribution apparatus for carrying out the data distribution method described in supplementary note 8 via the first distribution path; acquiring the provision data; generating the first provision information based on the provision data; transmitting the first provision information to the data distribution apparatus via the first distribution path; generating the second provision information based on the provision data upon receipt of notification for prompting connection to the second distribution path; transmitting the provision second information to the data distribution apparatus via the second distribution path; and transmitting the provision data to the usage apparatus via the second distribution path upon receipt of notification for prompting provision of the provision data.

According to the configuration, an effect similar to that of supplementary note 1 is brought about.

### (Supplementary Note 10)

A data usage method, including: being communicably connected to a data distribution apparatus for carrying out the data distribution method described in supplementary note 8 via the first distribution path; acquiring input data indicating the request; generating first request information based on the input data; transmitting the first request information to the data distribution apparatus via the first distribution path; generating the second request information based on the input data upon receipt of notification for prompting connection to the second distribution path; transmitting the second request information to the data distribution apparatus via the second distribution path; and receiving the provision data from the provision apparatus via the second distribution path.

According to the configuration, an effect similar to that of supplementary note 1 is brought about.

### (Supplementary Note 11)

A program for causing a computer to function as a data distribution apparatus, the program causing the computer to function as: a first reception means of receiving first provision information and first request information via a first distribution path, the first provision information pertaining to provision data which is providable by a provision apparatus, and the first request information indicating a request which is related to provision data and made by a usage apparatus; a first determination means of determining whether or not the first provision information and the first request information satisfy a first condition; a second distribution path notification means of providing the provision apparatus and the usage apparatus with notification for prompting the provision apparatus and the usage apparatus to connect to a second distribution path in a case where the first condition is satisfied, the second distribution path being private and different from the first distribution path; a second reception means of receiving second provision information and second request information via the second distribution path, the second provision information pertaining to the provision data and being more specific than the first provision information, and the second request information indicating the request and being more specific than the first request information; a second determination means of determining whether or not the second provision information and the second request information satisfy a second condition; and a provision notification means of providing the provision apparatus with notification for prompting the provision apparatus to provide the provision data to the usage apparatus via the second distribution path in a case where the second condition is satisfied.

According to the configuration, an effect similar to that of supplementary note 1 is brought about.

### (Supplementary Note 12)

A program for causing a computer to function as a provision apparatus, the program being communicably connected to a data distribution apparatus that executes the program described in supplementary note 11 via the first distribution path, and causing the computer to function as: a provision data acquisition means of acquiring the provision data; a first provision information generation means of generating the first provision information based on the provision data; a first provision information transmission means of transmitting the first provision information to the data distribution apparatus via the first distribution path; a second provision information generation means of generating the second provision information based on the provision data upon receipt of notification for prompting connection to the second distribution path; a second provision information transmission means of transmitting the second provision information to the data distribution apparatus via the second distribution path; and a provision data transmission means of transmitting the provision data to the usage apparatus via the second distribution path upon receipt of notification for prompting provision of the provision data.

According to the configuration, an effect similar to that of supplementary note 1 is brought about.

### (Supplementary Note 13)

A program for causing a computer to function as a usage apparatus, the program being communicably connected to a data distribution apparatus that executes the program described in supplementary note 11 via the first distribution path, and causing the computer to function as: an input data acquisition means of acquiring input data indicating the request; a first request information generation means of generating first request information based on the input data; a first request information transmission means of transmitting the first request information to the data distribution apparatus via the first distribution path; a second request information generation means of generating the second request information based on the input data upon receipt of notification for prompting connection to the second distribution path; a second request information transmission means of transmitting the second request information to the data distribution apparatus via the second distribution path; and a provision data reception means of receiving the provision data from the provision apparatus via the second distribution path.

According to the configuration, an effect similar to that of supplementary note 1 is brought about.

[Additional remark 3]

Furthermore, some of or all of the foregoing example embodiments can also be expressed as below.

A data distribution apparatus, including at least one processor, the at least one processor carrying out: a first reception process of receiving first provision information and first request information via a first distribution path, the first provision information pertaining to provision data which is providable by a provision apparatus, and the first request information indicating a request which is related to provision data and made by a usage apparatus; a first determination process of determining whether or not the first provision information and the first request information satisfy a first condition; a second distribution path notification process of providing the provision apparatus and the usage apparatus with notification for prompting the provision apparatus and the usage apparatus to connect to a second distribution path in a case where the first condition is satisfied, the second distribution path being private and different from the first distribution path; a second reception process of receiving second provision information and second request information via the second distribution path, the second provision information pertaining to the provision data and being more specific than the first provision information, and the second request information indicating the request and being more specific than the first request information; a second determination process of determining whether or not the second provision information and the second request information satisfy a second condition; and a provision notification process of providing the provision apparatus with notification for prompting the provision apparatus to provide the provision data to the usage apparatus via the second distribution path in a case where the second condition is satisfied.

Note that the data distribution apparatus can further include a memory. The memory can store a program for causing the processor to carry out the first reception process, the first determination process, the second distribution path notification process, the second reception process, the second determination process, and the provision notification process. The program can be stored in a computer-readable non-transitory tangible storage medium.

### REFERENCE SIGNS LIST

1, 1A, 1B, 1C: Data distribution system
200A: Guard management system
200B: Sensor value sales system
200C: Picture monitoring system
300A: Guard request system
10, 10B: Data distribution apparatus
20: Provision apparatus
20A: Management server
20B: Sales server
20C: Picture server
30: Usage apparatus
30A: Request server
30B: Purchasing apparatus
30C: Lost child search apparatus
11: First reception section
12: First determination section
13: Second distribution path notification section
14: Second reception section
15: Second determination section
16: Provision notification section
21: Provision data acquisition section
22: First provision information generation section
23: First provision information transmission section
24: Second provision information generation section
25: Second provision information transmission section
26: Provision data transmission section
31: Input data acquisition section
32: First request information generation section
33: First request information transmission section
34: Second request information generation section
35: Second request information transmission section
36: Provision data reception section

What is claimed is:

1. A data distribution apparatus, comprising at least one processor, the at least one processor carrying out:
a first reception process of receiving first provision information and first request information via a first distribution path, the first provision information pertaining to provision data which is providable by a provision apparatus, and the first request information indicating a request which is related to provision data and made by a usage apparatus;
a first determination process of determining whether or not the first provision information and the first request information satisfy a first condition;
a second distribution path notification process of providing the provision apparatus and the usage apparatus with notification for prompting the provision apparatus and the usage apparatus to connect to a second distribution path in a case where the first condition is satisfied, the second distribution path being private and different from the first distribution path;
a second reception process of receiving second provision information and second request information via the second distribution path, the second provision information pertaining to the provision data and being more specific than the first provision information, and the second request information indicating the request and being more specific than the first request information;
a second determination process of determining whether or not the second provision information and the second request information satisfy a second condition; and
a provision notification process of providing the provision apparatus with notification for prompting the provision apparatus to provide the provision data to the usage apparatus via the second distribution path in a case where the second condition is satisfied.

2. The data distribution apparatus according to claim 1, wherein:
in a case where the second condition is satisfied, the at least one processor transmits the second provision information to the usage apparatus in the provision notification process; and
in a case where the at least one processor has received confirmation information from the usage apparatus, the at least one processor provides, in the provision notification process, the provision apparatus with notification for prompting the provision apparatus to provide the provision data to the usage apparatus.

3. The data distribution apparatus according to claim 1, wherein:
in a case where the first condition is satisfied, the at least one processor transmits the first provision information to the usage apparatus in the second distribution path notification process; and
in a case where the at least one processor has received confirmation information from the usage apparatus, the at least one processor provides, in the second distribution path notification process, the provision apparatus and the usage apparatus with notification for prompting the provision apparatus and the usage apparatus to connect to the second distribution path.

4. The data distribution apparatus according to claim 1, wherein:
in a case where the at least one processor has determined in the second determination process that i-th provision information and i-th request information satisfy an i-th condition, in the second reception process, the at least one processor receives, for i which is 2, . . . , and n-1 (n is an integer of 3 or more), (i+1)th provision information and (i+1)th request information via the second distribution path, the (i+1)th provision information pertaining to the provision data and being more specific than the i-th provision information, and the (i+1)th request information indicating the request and being more specific than the i-th request information; and
in a case where n-th provision information and n-th request information satisfy an n-th condition, the at least one processor provides, in the provision notification process, the provision apparatus with notification for prompting the provision apparatus to provide the provision data to the usage apparatus.

5. A provision apparatus which is communicably connected to a data distribution apparatus recited in claim 1 the first distribution path, said provision apparatus comprising at least one processor, the at least one processor carrying out:
a provision data acquisition process of acquiring the provision data;
a first provision information generation process of generating the first provision information based on the provision data;
a first provision information transmission process of transmitting the first provision information to the data distribution apparatus via the first distribution path;
a second provision information generation process of generating the second provision information based on the provision data upon receipt of notification for prompting connection to the second distribution path;
a second provision information transmission process of transmitting the second provision information to the data distribution apparatus via the second distribution path; and
a provision data transmission process of transmitting the provision data to the usage apparatus via the second distribution path upon receipt of notification for prompting provision of the provision data.

6. A usage apparatus which is communicably connected to a data distribution apparatus recited in claim 1 via the first distribution path, said usage apparatus comprising at least one processor, the at least one processor carrying out:
an input data acquisition process of acquiring input data indicating the request;
a first request information generation process of generating first request information based on the input data;
a first request information transmission process of transmitting the first request information to the data distribution apparatus via the first distribution path;
a second request information generation process of generating the second request information based on the input data upon receipt of notification for prompting connection to the second distribution path;
a second request information transmission process of transmitting the second request information to the data distribution apparatus via the second distribution path; and
a provision data reception process of receiving the provision data from the provision apparatus via the second distribution path.

7. A data distribution system, comprising:
a data distribution apparatus recited in claim 1;
a provision apparatus which is communicably connected to the data distribution apparatus via the first distribution path; and
a usage apparatus which is communicably connected to the data distribution apparatus via the first distribution path,
the provision apparatus including at least one processor, the at least one processor carrying out
a provision data acquisition process of acquiring the provision data,
a first provision information generation process of generating the first provision information based on the provision data,
a first provision information transmission process of transmitting the first provision information to the data distribution apparatus via the first distribution path,
a second provision information generation process of generating the second provision information based on the provision data upon receipt of notification for prompting connection to the second distribution path,
a second provision information transmission process of transmitting the second provision information to the data distribution apparatus via the second distribution path, and
a provision data transmission process of transmitting the provision data to the usage apparatus via the second distribution path upon receipt of notification for prompting provision of the provision data, and
the usage apparatus including at least one processor, the at least one processor carrying out
an input data acquisition process of acquiring input data indicating the request,
a first request information generation process of generating first request information based on the input data,
a first request information transmission process of transmitting the first request information to the data distribution apparatus via the first distribution path,
a second request information generation process of generating the second request information based on the input data upon receipt of notification for prompting connection to the second distribution path,
a second request information transmission process of transmitting the second request information to the data distribution apparatus via the second distribution path, and
a provision data reception process of receiving the provision data from the provision apparatus via the second distribution path.

8. A data distribution method, comprising:
receiving first provision information and first request information via a first distribution path, the first provision information pertaining to provision data which is providable by a provision apparatus, and the first request information indicating a request which is related to provision data and made by a usage apparatus;
determining whether or not the first provision information and the first request information satisfy a first condition;
providing the provision apparatus and the usage apparatus with notification for prompting the provision apparatus and the usage apparatus to connect to a second distribution path in a case where the first condition is satisfied, the second distribution path being private and different from the first distribution path;
receiving second provision information and second request information via the second distribution path, the second provision information pertaining to the provision data and being more specific than the first provision information, and the second request information indicating the request and being more specific than the first request information;
determining whether or not the second provision information and the second request information satisfy a second condition; and
providing the provision apparatus with notification for prompting the provision apparatus to provide the provision data to the usage apparatus via the second distribution path in a case where the second condition is satisfied.

9. A data provision method, comprising:
being communicably connected to a data distribution apparatus for carrying out a data distribution method recited in claim 8 via the first distribution path;
acquiring the provision data;
generating the first provision information based on the provision data;
transmitting the first provision information to the data distribution apparatus via the first distribution path;
generating the second provision information based on the provision data upon receipt of notification for prompting connection to the second distribution path;
transmitting the second provision information to the data distribution apparatus via the second distribution path; and
transmitting the provision data to the usage apparatus via the second distribution path upon receipt of notification for prompting provision of the provision data.

10. A data usage method, comprising:
being communicably connected to a data distribution apparatus for carrying out a data distribution method recited in claim 8 via the first distribution path;
acquiring input data indicating the request;
generating first request information based on the input data;
transmitting the first request information to the data distribution apparatus via the first distribution path;
generating the second request information based on the input data upon receipt of notification for prompting connection to the second distribution path;
transmitting the second request information to the data distribution apparatus via the second distribution path; and
receiving the provision data from the provision apparatus via the second distribution path.

11. A non-transitory storage medium storing a program for causing a computer to function as a data distribution apparatus, the program causing the computer to carry out:
a first reception process of receiving first provision information and first request information via a first distribution path, the first provision information pertaining to provision data which is providable by a provision apparatus, and the first request information indicating a request which is related to provision data and made by a usage apparatus;
a first determination process of determining whether or not the first provision information and the first request information satisfy a first condition;
a second distribution path notification process of providing the provision apparatus and the usage apparatus with notification for prompting the provision apparatus and the usage apparatus to connect to a second distribution path in a case where the first condition is satisfied, the second distribution path being private and different from the first distribution path;
a second reception process of receiving second provision information and second request information via the second distribution path, the second provision information pertaining to the provision data and being more specific than the first provision information, and the second request information indicating the request and being more specific than the first request information;
a second determination process of determining whether or not the second provision information and the second request information satisfy a second condition; and
a provision notification process of providing the provision apparatus with notification for prompting the provision apparatus to provide the provision data to the usage apparatus via the second distribution path in a case where the second condition is satisfied.

12. A non-transitory storage medium storing a program for causing a computer to function as a provision apparatus, the program being communicably connected to a data distribution apparatus that executes a program recited in claim 11 via the first distribution path, and causing the computer to carry out:
a provision data acquisition process of acquiring the provision data;
a first provision information generation process of generating the first provision information based on the provision data;
a first provision information transmission process of transmitting the first provision information to the data distribution apparatus via the first distribution path;
a second provision information generation process of generating the second provision information based on the provision data upon receipt of notification for prompting connection to the second distribution path;
a second provision information transmission process of transmitting the second provision information to the data distribution apparatus via the second distribution path; and
a provision data transmission process of transmitting the provision data to the usage apparatus via the second distribution path upon receipt of notification for prompting provision of the provision data.

13. A non-transitory storage medium storing a program for causing a computer to function as a usage apparatus, the program being communicably connected to a data distribution apparatus that executes a program recited in claim 11 via the first distribution path, and causing the computer to carry out:
an input data acquisition process of acquiring input data indicating the request;
a first request information generation process of generating first request information based on the input data;
a first request information transmission process of transmitting the first request information to the data distribution apparatus via the first distribution path;
a second request information generation process of generating the second request information based on the input data upon receipt of notification for prompting connection to the second distribution path;
a second request information transmission process of transmitting the second request information to the data distribution apparatus via the second distribution path; and
a provision data reception process of receiving the provision data from the provision apparatus via the second distribution path.
